(19) United States
(12) Patent Application Publication
(10) Pub. No.: US 2025/0380284 A1
(43) Pub. Date: Dec. 11, 2025

(54) SIDELINK TRANSMISSION METHOD AND APPARATUS, AND TERMINAL DEVICE

(71) Applicant: VIVO MOBILE COMMUNICATION CO., LTD., Dongguan (CN)

(72) Inventors: Ping LI, Dongguan (CN); Yuming YANG, Dongguan (CN); Zichao JI, Dongguan (CN)

(21) Appl. No.: 19/301,115

(22) Filed: Aug. 15, 2025

Related U.S. Application Data
(63) Continuation of application No. PCT/CN2024/076747, filed on Feb. 7, 2024.

(30) Foreign Application Priority Data
Feb. 17, 2023 (CN) 202310142178.9

(51) Int. Cl. H04W 72/40; H04W 72/0446; H04W 72/1263

(52) U.S. Cl. CPC H04W 72/40; H04W 72/0446; H04W 72/1263

(57) ABSTRACT

This application discloses a sidelink transmission method and apparatus, and a terminal device, and belongs to the field of communication technologies. The sidelink transmission method in embodiments of this application includes: determining, by a terminal device, a transport block size and/or second-stage sidelink control information according to first information; and performing, by the terminal device, sidelink transmission according to the transport block size and/or the second-stage sidelink control information, where the first information includes at least one of the following: a first parameter, where the first parameter is used for indicating time domain resource information used for sidelink transmission in one slot; a first coefficient, where the first coefficient is used for indicating a scaling ratio of a resource used for sidelink transmission in one slot; and information about physical resource blocks scheduled by the terminal device.

### CROSS-REFERENCE TO RELATED APPLICATIONS

This application is a bypass continuation application of International Application No. PCT/CN2024/076747, filed on Feb. 7, 2024, which claims the benefit of and priority to Chinese Patent Application No. 202310142178.9, filed on Feb. 17, 2023 and entitled “SIDELINK TRANSMISSION METHOD AND APPARATUS AND TERMINAL DEVICE”, the contents of which being incorporated by reference in their entireties herein.

### TECHNICAL FIELD

This application relates to the field of communication technologies and, more specifically, relates to a sidelink transmission method and apparatus and a terminal device.

### BACKGROUND

In an unlicensed band of sidelink (SL), at present, it is agreed to introduce two start symbol positions to increase a probability of successful listen before talk (LBT).

### BRIEF SUMMARY

According to a first aspect, a sidelink transmission method is provided, including:
determining, by a terminal device, a transport block size and/or second-stage sidelink control information according to first information; and
performing, by the terminal device, sidelink transmission according to the transport block size and/or the second-stage sidelink control information;
where the first information includes at least one of the following:
a first parameter, where the first parameter is used for indicating time domain resource information used for sidelink transmission in one slot;
a first coefficient, where the first coefficient is used for indicating a scaling ratio of a resource used for sidelink transmission in one slot; and
information about physical resource blocks scheduled by the terminal device.

According to a second aspect, a sidelink transmission apparatus is provided, including:
a first determining module, configured to determine a transport block size and/or second-stage sidelink control information according to first information; and
a first transmission module, configured to perform sidelink transmission according to the transport block size and/or the second-stage sidelink control information;
where the first information includes at least one of the following:
a first parameter, where the first parameter is used for indicating time domain resource information used for sidelink transmission in one slot;
a first coefficient, where the first coefficient is used for indicating a scaling ratio of a resource used for sidelink transmission in one slot; and
information about physical resource blocks scheduled by the terminal device.

According to a third aspect, a terminal device is provided, where the terminal includes a processor and a memory, the memory stores a program or instructions capable of running on the processor, and the program or the instructions are executed by the processor to implement the steps of the sidelink transmission method according to the first aspect.

According to a fourth aspect, a sidelink transmission system is provided, including a network side device and a terminal device, where the terminal device may be configured to perform the steps of the sidelink transmission method according to the first aspect.

According to a fifth aspect, a readable storage medium is provided. The readable storage medium stores a program or instructions, and when executed by a processor, the program or the instructions implement the steps of the sidelink transmission method according to the first aspect.

According to a sixth aspect, a chip is provided, where the chip includes a processor and a communication interface, the communication interface is coupled to the processor, and the processor is configured to run a program or instructions to implement the sidelink transmission method according to the first aspect.

According to a seventh aspect, a computer program/program product is provided. The computer program/program product is stored in a storage medium. The computer program/program product is executed by at least one processor to implement the steps of the sidelink transmission method according to the first aspect.

### BRIEF DESCRIPTION OF THE DRAWINGS

FIG. 1 is a block diagram of a wireless communication system applicable to an embodiment of this application;

FIG. 2 is a schematic diagram of a slot structure of NR SL;

FIG. 3 is an index table of a TBS;

FIG. 4 is a schematic structural diagram of a slot of SL;

FIG. 5 is a flowchart of a sidelink transmission method according to an embodiment of this application;

FIG. 6 is a schematic structural diagram of a slot according to an embodiment of this application;

FIG. 7 is another schematic structural diagram of a slot according to an embodiment of this application;

FIG. 8 is still another schematic structural diagram of a slot according to an embodiment of this application;

FIG. 9 is another schematic structural diagram of a slot according to an embodiment of this application;

FIG. 10 is a structural block diagram of a sidelink transmission apparatus according to an embodiment of this application;

FIG. 11 is a structural block diagram of a communication device according to an embodiment of this application; and

FIG. 12 is a structural block diagram of a terminal device according to an embodiment of this application.

### DETAILED DESCRIPTION

The following describes the technical solutions in embodiments of this application with reference to the accompanying drawings in the embodiments of this application. Understandably, the described embodiments are some, but not all, of the embodiments of this application. All other embodiments obtained by a person of ordinary skill in the art based on the embodiments of this application shall fall within the protection scope of this application.

In the specification and claims of this application, the terms “first” and “second” are used to distinguish between similar objects, but are unnecessarily used to describe a specific sequence or order. It should be understood that the terms in such a way are exchangeable in a proper case, so that the embodiments of this application described herein can be implemented in an order other than the order shown or described herein. In addition, objects distinguished by “first”, “second”, and the like are generally of one type, and a number of objects is not limited. For example, there may be one or more first objects. In addition, “and/or” in this specification and the claims represents at least one of the connected objects, and the character “/” generally represents an “or” relationship between the associated objects.

It should be noted that technologies described in embodiments of this application are not limited to a Long Term Evolution (LTE)/LTE-Advanced (LTE-A) system, and may be further applied to another wireless communication system such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-LTE-A), and another system. The terms “system” and “network” in the embodiments of this application are often used interchangeably. The described technology may be used in the foregoing system and radio technology, or may be used in another system and radio technology. The following describes a new radio (NR) system for illustrative purposes, and NR terms are used in most of the following descriptions. However, these technologies are also applicable to applications such as a 6^{th} generation (6G) communication system other than NR system applications.

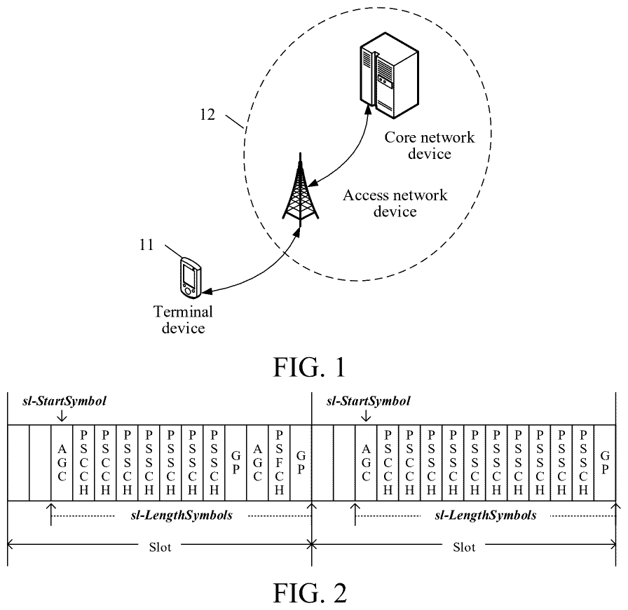

FIG. 1 is a block diagram of a wireless communication system applicable to an embodiment of this application. The wireless communication system includes a terminal device 11 and a network side device 12. The terminal device 11 may be a mobile phone, a tablet personal computer, a laptop computer also referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a laundry machine, or a furniture), a gaming console, a personal computer (PC), a teller machine, a self-service machine, or another terminal side device. The wearable device includes a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal device 11 is not limited in embodiments of this application. The network-side device 12 can include an access network device or a core network device. The access network device 12 can also be referred to as a radio access network device, a radio access network (RAN), a radio access network function, or a radio access network unit. The access network device 12 may include a base station, a WLAN access point, a WiFi node, or the like. The base station may be referred to as a node B, an evolved node B, an access point, a base transceiver station (BTS), a radio base station, a radio transceiver, a basic service set (BSS), an extended service set (ESS), a home node B, a home evolved node B, a transmitting receiving point (TRP), or some other suitable term in the art, as long as the same technical effect is achieved. The base station is not limited to specific technical vocabulary. It is to be understood that in embodiment of this application, only the base station in the NR system is used as an example, but the specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (PCRF), an edge application server discovery function (EASDF), unified data management (UDM), unified data repository (UDR), a home subscriber server (HSS), centralized network configuration (CNC), a network repository function (NRF), a network exposure function (NEF), a local NEF (L-NEF), a binding support function (BSF), an application function (AF), and the like. It should be noted that in embodiments of this application, only a core network device in an NR system is used as an example for description, and a specific type of the core network device is not limited.

A long term evolution (LTE) system supports sidelink (SL) from Release 12, to perform direct data transmission between user equipments (UE) without using a network device.

An LTE sidelink design supports two resource allocation modes, which are respectively a scheduled resource allocation mode and an autonomous resource selection mode. The former is controlled by a network side device and allocates a resource for each UE, and the latter supports autonomous selection of a resource by the UE.

Starting from Release 15, LTE supports sidelink carrier aggregation (CA). LTE sidelink CA is different from a Uu interface (that is, downlink and uplink), and there is no primary component carrier (PCC) and secondary component carrier (SCC). The UE in the autonomous resource selection mode independently performs resource sensing and resource reservation on each CC.

The design of LTE sidelink is suitable for specific public safety affairs (such as emergency communication in fire or earthquake disaster areas), or vehicle to everything (V2X) communication. Vehicle to everything communication includes various services, such as basic security communication, advanced (autonomous) driving, fleet formation, sensor extension, and so on. Because LTE sidelink supports only broadcast communication, LTE sidelink is mainly used for basic security communication, and other advanced V2X services are supported by NR sidelink.

A 5G NR system may be used in an operating frequency band above 6 GHz that is not supported by LTE, and supports a larger operating bandwidth. The NR system also supports sidelink interface communication for direct communication between terminals.

FIG. 2 is a schematic structural diagram of a slot of new radio (NR) SL. As shown in FIG. 2, a sidelink slot includes at least one of automatic gain control (AGC), a physical sidelink control channel (PSCCH), a physical sidelink share channel (PSSCH), a physical sidelink feedback channel (PSFCH), and a guard period (GP), and the PSCCH may be multiplexed with the PSSCH.

In a related technology, calculating a transport block size in NR SL mainly includes the following steps:

1. Calculate a number of available resource elements (RE) in one slot and/or a number of REs occupied by a PSSCH:

$${N}_{RE} = {N}_{RE}^{′} \cdot {n}_{PRB} - {N}_{RE}^{SCI , 1} - {N}_{RE}^{SCI , 2} \qquad ( 1 )$$

where n_{PRB} is a number of physical resource blocks (PRB) occupied by the PSSCH;

$${N}_{RE}^{SCI , 1}$$

is a number of KES occupied by first-stage sidelink control information (SCI), and may specifically include REs occupied by a PSCCH and a demodulation reference signal (DMRS) of the PSCCH; and

$${N}_{RE}^{SCI , 2}$$

is a number of KES occupied by second-stage SCI, and the second-stage SCI is used for storing information of receive UE.

N_{RE}′ is a number of REs that can be used for a PSSCH in one PRB, and may be specifically represented as:

$${N}_{RE}^{′} = {N}_{sc}^{RB} ( {N}_{symb}^{sh} - {N}_{symb}^{PSFCH} ) - {N}_{oh}^{PRB} - {N}_{RE}^{DMRS} \qquad ( 2 )$$

where

$${N}_{sc}^{RB} = 12$$

represents a number or subcarriers in one PRB.

$${N}_{symb}^{sh} = sl - LengthSymbols - 2$$

represents a number of symbols that can be used for sidelink in one slot, and does not include a last GP symbol and a first symbol used for AGC.

$${N}_{symb}^{PSFCH} = 0$$

or 3, is a number of symbols occupied by a PSFCH, and may be determined according to a “PSFCH overhead indication” (“PSFCH overhead indication”) field indication in the first-stage SCI.

$${N}_{oh}^{PRB}$$

is overheads provided for configuring sl-X-Overhead by a high layer and is used for indicating numbers of REs occupied by a PT-RS and a CSI-RS.

$${N}_{RE}^{DMRS}$$

is an average number of DMRS REs in one slot, and is determined according to Table 8.1.3.2-1 and sl-PSSCH-DMRS-TimePattern configured by a high layer. Table 8.1.3.2-1, a configuration list of

$${N}_{RE}^{DMRS}$$

according to a high-layer parameter sl-PSSCH-DMRS-TimePattern is shown in Table 1:

TABLE 1

| sl-PSSCH-DMRS-TimePatternList | N_{RE}^{DMRS} |
|---|---|
| {2} | 12 |
| {3} | 18 |
| {4} | 24 |
| {2, 3} | 15 |
| {2, 4} | 18 |
| {3, 4} | 21 |
| {2, 3, 4} | 18 |

2. Calculate an information intermediate number:

$${N}_{info} = {N}_{RE} \cdot R \cdot {Q}_{m} \cdot υ \qquad ( 3 )$$

When N_{info}≤3824, step 3 is used; otherwise, step 4 is used.

3. When N_{info}≤3824, an intermediate number is quantized, where n=max(3,└log₂(N_{info})┘−6). A latest TBS not less than

$${N}_{info}^{′}$$

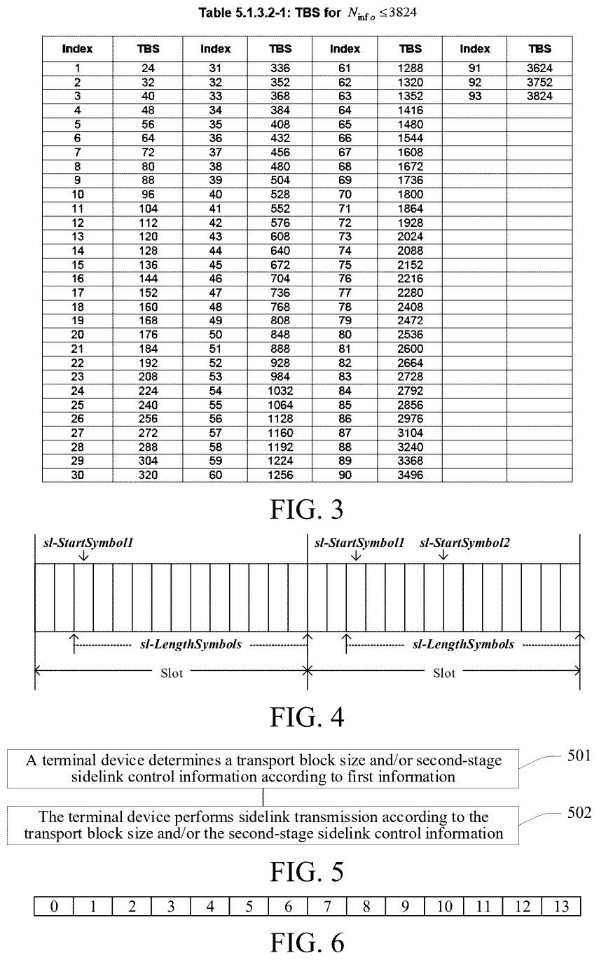

is found in an index table of a TBS shown in FIG. 3.

4. When N_{info}>3824, the intermediate number

$${N}_{info}^{′} = max ( 3840 , {2}^{″} \times round ( \frac{{N}_{info} - 24}{{2}^{″}} ) )$$

is quantized, where n=└log₂(N_{info}−24)┘−5.

A number of REs or a number of coded modulation symbols occupied by the second-stage SCI may be calculated according to the following formula:

$${Q}_{SCI 2}^{′} = min \{ ⌈ \frac{( {O}_{SCI 2} + {L}_{SCI 2} ) \cdot {β}_{offset}^{SCI 2}}{{Q}_{m}^{SCI 2} \cdot R} ⌉ , ⌈ α {\sum }_{l = 0}^{{N}_{symbol}^{PSSCH} - 1} {M}_{sc}^{SCI 2} ( l ) ⌉ \} + γ \qquad ( 4 )$$

where O_{SCI2} represents a number of second-stage SCI information bits, and is determined by a format of the second-stage SCI.

L_{SCI2} represents a CRC length of the second-stage SCI, and is 24 bits.

$${β}_{offset}^{SCI 2}$$

is a code rate offset of the second-stage SCI, and is indicated by using the first-stage SCI.

$${Q}_{m}^{SCI 2} = 2$$

is a modulation order of the second-stage SCI.

R is a code rate corresponding to an MCS index indicated in a “modulation coding scheme (MCS)” indication field in the first-stage SCI.

$${M}_{sc}^{SCI 2} ( l ) = {M}_{sc}^{PSSCH} ( l ) - {M}_{sc}^{PSSCH} ( l )$$

represents a number of REs that can be used to map the second-stage SCI on a first OFDM symbol.

$$l = 0 , 1 , 2 , ... , {N}_{symbol}^{PSSCH} - 1 and {N}_{symbol}^{PSSCH} = {N}_{symb}^{sh} - {N}_{symb}^{PSFCH} ,$$

where

$${N}_{symb}^{sh} = sl - lengthSymbols - 2$$

represents OFDM symbols other that the first AGC symbol and the last GP symbol that can be used for sidelink in a current slot; and

$${N}_{symb}^{PSFCH} = 0$$

or 3, is a number of symbols occupied by the PSFCH, and is determined according to a “PSFCH overhead indication” field indication in the first-stage SCI.

A value of γ is 0 to 11, representing a number of REs rest in a PRB in which a last second-stage SCI modulation symbol is located, and the parameter is used to ensure that a resource occupied by the second-stage SCI is an integer number of PRBs.

α is maximum spectral efficiency of the second-stage SCI configured for RRC.

There are two resource allocation modes for NR SL: One is based on base station scheduling (mode 1), and the other is based on UE autonomous resource selection (mode 2). For the resource allocation mode of base station scheduling, a sidelink resource used by UE for data transmission is determined by a base station, and TX UE is notified by using downlink signaling. For the resource allocation mode of UE autonomous selection, the UE selects an available transmission resource from a (pre-) configured resource pool. Before resource selection, the UE first performs channel sensing, selects a resource set with less interference according to a sensing result, and then randomly selects a resource used for transmission from the resource set.

For mode 2, a specific working manner is as follows:

1) After resource selection is triggered, TX UE first determines a resource selection window. A lower boundary of the resource selection window is at time T1 after resource selection is triggered, and an upper boundary of the resource selection is at time T2 after resource selection is triggered. T2 is a value selected by a manner implemented by the UE from a packet delay budget (PDB) transmitted on a TB of the TX UE, and T2 is not earlier than T1.

2) Before resource selection, the UE needs to determine a candidate resource set for resource selection, compare reference signal receiving power (RSRP) measured on a resource in the resource selection window with a corresponding RSRP threshold, and if the RSRP is higher than the RSRP threshold, perform resource exclusion on the resource, which then cannot be included in the candidate resource set. After resource exclusion is performed, rest resources in the resource selection window form the candidate resource set. A proportion of resources in the candidate resource set in resources in the resource selection window needs to be not less than x %. If the proportion is less than x %, the RSRP threshold needs to be increased according to a step value (3 dB), and the resource exclusion operation is performed until not less than x % of resources can be selected.

3) After the candidate resource set is determined, the UE randomly selects a transmission resource from the candidate resource set. In addition, the UE may reserve a transmission resource for next transmission during current transmission.

Step 2) is divided into 7 sub-steps in a standard for description as follows:

Step 1): The UE determines candidate resources based on the resource selection window, and a total number of the candidate resources is recorded as M_total.

Step 2): The UE obtains a sensing result, for example, reservation information in a PSSCH, and an RSRP measurement value associated with a reserved resource, in a sensing window.

Step 3): The UE determines an initial RSRP threshold.

Step 4): The UE initializes a candidate resource set, including all candidate resources (which may also be referred to as all candidate resources in the resource selection window) determined in step 1).

Step 5): The UE performs resource exclusion based on a non-monitored slot, to exclude a resource meeting a first preset condition from the candidate resource set.

Step 5a): Restore the candidate resource set to the initial candidate resource set determined in step 4) if a number of rest resources in the candidate resource set is less than x %*M_total after resource exclusion is performed based on step 5).

Step 6): The UE performs resource exclusion based on comparison between an RSRP measurement value and the RSRP threshold, to exclude a resource meeting a second preset condition from the candidate resource set.

Step 7): If the number of rest resources in the candidate resource set is less than x %*M_total after resource exclusion is performed based on step 6), increase the RSRP threshold by 3 dB, and go back to step 4).

FIG. 4 is a schematic structural diagram of a slot of SL. As shown in FIG. 4, in an unlicensed band of sidelink, at present, two start symbol positions are introduced to increase a probability of successful LBT. However, due to uncertainty of LBT, initial transmission and retransmission may be sent at two different start symbol positions. For example, initial transmission of transmit user equipment (TX UE) is sent at a start symbol position 1, retransmission thereof is sent at a start symbol position 2, and the TX UE determines a transport block size (TBS) according to a sending resource. Consequently, understanding of the TBS during the initial transmission and the retransmission is inconsistent. In addition, the TX UE needs to prepare a transport block (TB) in advance. However, it may happen that the TX UE determines the TBS according to a length of a resource sent at the start symbol position 1, and LBT succeeds at the start symbol position 2. As a result, a sending code rate becomes high, and consequently, receive UE (RX UE) cannot correctly perform reception. Alternatively, the TX UE determines the TBS according to a length of a resource sent at the start symbol position 2, and LBT succeeds at the start symbol position 1. Consequently, resource utilization is reduced. In addition, for sidelink transmission on an unlicensed band, due to existence of a guardband and introduction of a transmission structure of an interlace, the TX UE may also determine the TBS according to a sending resource. Consequently, understanding of the TBS during initial transmission and retransmission is inconsistent. Therefore, how to determine the TBS for sidelink transmission on an unlicensed band, or to avoid occurrence of the foregoing problem according to resource selection needs to be designed.

With reference to the accompanying drawings, the following describes in detail the sidelink transmission method provided in embodiments of this application by using some embodiments and application scenarios thereof.

Embodiments of this application provide a sidelink transmission method and apparatus, a network side device, and a terminal device, to resolve a problem that transmission resources during initial transmission and retransmission are inconsistent.

According to a first aspect, an embodiment of this application provides a sidelink transmission method. FIG. 5 is a flowchart of a sidelink transmission method according to an embodiment of this application. The method is applied to a terminal device. As shown in FIG. 5, the method may specifically include the following steps.

Step 501: The terminal device determines a transport block size and/or second-stage sidelink control information according to first information.

Step 502: The terminal device performs sidelink transmission according to the transport block size and/or the second-stage sidelink control information.

The first information includes at least one of the following:
a first parameter, where the first parameter is used for indicating time domain resource information used for sidelink transmission in one slot;
a first coefficient, where the first coefficient is used for indicating a scaling ratio of a resource used for sidelink transmission in one slot; and
information about physical resource blocks scheduled by the terminal device.

In embodiments of this application, the terminal device determines the transport block size and/or the second-stage SCI according to the first information and performs sidelink transmission, to ensure consistency of transmission resources during initial transmission and retransmission, thereby improving effectiveness of sidelink transmission and improving resource utilization.

Optionally, the first information includes the first parameter, and that the terminal device determines a transport block size and/or second-stage sidelink control information according to first information includes:
The terminal device determines a scheduling symbol number according to second information; and
the terminal device determines the transport block size and/or the second-stage sidelink control information according to the scheduling symbol number;
where the second information includes at least one of the following:
a first parameter, where the first parameter is used for indicating time domain resource information used for sidelink transmission in one slot;
an automatic gain control symbol number, where the automatic gain control symbol number is used for indicating a number of symbols occupied by automatic gain control in one slot; and
a guard symbol number, where the guard symbol number is used for indicating a number of symbols occupied by a guard period.

It should be noted that, the scheduling symbol number

$${N}_{symbol}^{sh}$$

is related to at least one of the first parameter, the automatic gain control symbol number, and the guard symbol number.

In an example, the scheduling symbol number is the first parameter minus a fourth parameter, and the fourth parameter includes the automatic gain control symbol number and/or the guard symbol number. For example, if the first parameter is determined based on a first start symbol, the first parameter is sl-LengthSymbols, that is, a number of symbols that can be used for sidelink transmission in one slot. If the first parameter is determined based on a second start symbol, the first parameter is sl-LengthSymbols-sl-(StartSymbol2-StartSymbol1), that is, the number of symbols that can be used for sidelink transmission in one slot minus a symbol interval between a number of first start symbols and a number of second symbols. For example,

$${N}_{symbol}^{sh}$$

is the first parameter minus 2, that is, the first parameter minus the automatic gain control symbol number and the guard symbol number. Available REs in one PRB are:

$${N}_{RE}^{′} = {N}_{sc}^{RB} ( {N}_{symb}^{sh} - {N}_{symb}^{PSFCH} ) - {N}_{oh}^{PRB} - {N}_{RE}^{DMRS} \qquad ( 5 )$$

and/or, a number of REs that can be used for the second-stage SCI is:

$${Q}_{SCI 2}^{′} = min \{ ⌈ \frac{( {O}_{SCI 2} + {L}_{SCI 2} ) \cdot {β}_{offset}^{SCI 2}}{{Q}_{m}^{SCI 2} \cdot R} ⌉ , ⌈ α {\sum }_{l = 0}^{{N}_{symbol}^{PSSCH} - 1} {M}_{sc}^{SCI 2} ( l ) ⌉ \} + γ \qquad ( 6 )$$

where,

$${N}_{symbol}^{PSSCH} = {N}_{symb}^{sh} - {N}_{symb}^{PSFCH} .$$

Optionally, the first coefficient is determined according to the first parameter.

For example, according to different first parameters, first coefficients corresponding to the first parameters are predefined in a protocol/configured by a network/preconfigured by UE/determined by the UE.

For example, if the first parameter is a first reference symbol length L1 determined based on the first start symbol, the first coefficient & may be 1; or if the first parameter is a second reference symbol length L2 determined based on the second start symbol, the first coefficient may be a ratio of the second parameter symbol length to the first reference symbol length, that is, S=L2/L1.

Alternatively, if the first parameter is the second reference symbol length determined based on the second start symbol, the first coefficient may be 1; or if the first parameter is the first reference symbol length determined based on the first start symbol, the first coefficient may be a ratio of the first reference symbol length to the second reference symbol length, that is, S=L1/L2.

For example, if the first parameter is the first start symbol, the first coefficient may be S1; or if the first parameter is the second start symbol, the first coefficient may be S2.

When an available RE in one PRB is calculated, the available RE may be scaled according to the first coefficient S. For example,

$${N}_{RE}^{′} = ( {N}_{sc}^{RB} \cdot {N}_{symbol}^{sh} - {N}_{DMRS}^{PRB} - {N}_{oh}^{PRB} ) \cdot S .$$

And/or, a PRB scheduled by the terminal device may be first scaled according to the first coefficient, and then a total number of REs is calculated. For example,

$${N}_{RE} = {N}_{RE}^{′} \cdot {n}_{PRB} \cdot S - {N}_{RE}^{SCI , 1} - {N}_{RE}^{SCI , 2} .$$

And/or, intermediate information of a TBS obtained through calculation is scaled according to the first coefficient. For example, N_{info}=N_{RE}·R·Qₘ·v·S.

And/or, when an RE that can be used for the second-stage SCI is calculated, the RE that can be used for the second-stage SCI may be scaled according to the first coefficient. For example,

$${Q}_{SCI 2}^{′} = min \{ ⌈ \frac{( {O}_{SCI 2} + {L}_{SCI 2} ) \cdot {β}_{offset}^{SCI 2}}{{Q}_{m}^{SCI 2} \cdot R} ⌉ , ⌈ S \cdot α {\sum }_{l = 0}^{{N}_{symbol}^{PSSCH} - 1} {M}_{sc}^{SCI 2} ( l ) ⌉ \} + γ .$$

In an optional embodiment of this application, the first information includes the first parameter, and that the terminal device determines a transport block size and/or second-stage sidelink control information according to first information includes:

The terminal device calculates a difference between a scheduling symbol number and a second parameter, where the scheduling symbol number is used for indicating a number of symbols used for sidelink transmission in one slot, and the second parameter is used for indicating a sidelink transmission overhead in one slot; and
the terminal device determines the transport block size and/or the second-stage sidelink control information according to the difference between the scheduling symbol number and the second parameter.

The second parameter includes a third parameter and/or a physical sidelink feedback channel PSFCH overhead, the third parameter is determined according to the first parameter, and the PSFCH overhead is determined according to PSFCH configuration information and/or the first parameter.

In an example, at least one of a protocol, a network side device, and a terminal device may configure a corresponding third parameter according to the first parameter.

In another example, the third parameter may be determined by subtracting the first parameter from the scheduling symbol number. The scheduling symbol number

$${N}_{symbol}^{sh}$$

is a number of (all) symbols that can be used for sidelink transmission in one slot. For example, the third parameter may be 0, or the second start symbol minus the first start symbol. Alternatively, if the first parameter is the first reference symbol length determined based on the first start symbol, the third parameter is 0; or if the first parameter is the second reference symbol length determined based on the second start symbol, the third parameter may be the second start symbol minus the first start symbol (that is, the scheduling symbol number minus the reference symbol length).

Optionally, when a configuration period of a PSFCH occasion is greater than a PSFCH period, PSFCH overheads may be determined according to the configuration period of the PSFCH occasion. The configuration period of the PSFCH occasion is an actual period of the PSFCH occasion. For example, not all PSFCH periods have an actual PSFCH occasion, but one PSFCH occasion exists in every two PSFCH periods. Therefore, the configuration period of the PSFCH occasion is two PSFCH periods.

For example, the scheduling symbol number

$${N}_{symbol}^{sh}$$

is a number of (all) symbols that can be used for sidelink transmission in one slot, excluding an AGC symbol and a GP symbol, that is,

$${N}_{symbol}^{sh} = sl - LengthSymbols ‐ 2.$$

An available RE in one PRB is

$${N}_{RE}^{′} = {N}_{sc}^{RB} ( {N}_{symb}^{sh} - {N}_{symb}^{PSFCH} - {N}_{symb}^{reference} ) - {N}_{oh}^{PRB} - {N}_{RE}^{DMRS} ,$$

and/or, a number of REs that can be used for the second-stage SCI is

$${Q}_{SCI 2}^{′} = min \{ ⌈ \frac{( {O}_{SCI 2} + {L}_{SCI 2} ) \cdot {β}_{offset}^{SCI 2}}{{Q}_{m}^{SCI 2} \cdot R} ⌉ , ⌈ α {\sum }_{l = 0}^{{N}_{symbol}^{PSSCH} - 1} {M}_{sc}^{SCI 2} ( l ) ⌉ \} + γ ,$$

where

$${N}_{symbol}^{PSSCH} = {N}_{symb}^{sh} - {N}_{symb}^{PSFCH} - {N}_{symb}^{reference} .$$

Optionally, the information about the physical resource block scheduled by the terminal device includes at least one of the following:
a number of physical resource blocks scheduled by the terminal device;
a number of resource elements included in the physical resource block;
a number of resource elements occupied by first-stage sidelink control information; and
a number of resource elements occupied by the second-stage sidelink control information.

It should be noted that in this embodiment of this application, the resource element (RE) may be a subcarrier in frequency domain, or may be a symbol in time domain.

In a calculation process of the TBS, a number of REs occupied by a PSSCH is related to at least one of a number of scheduled PRBs, a number of available REs in one PRB, a number of REs occupied by the first-stage SCI, and a number of REs occupied by the second-stage SCI. For example, the number of REs occupied by the PSSCH=the number of scheduled PRBs multiplied by the number of available REs in one PRB minus the number of REs occupied by the first-stage SCI minus the number of REs occupied by the second-stage SCI.

And/or, when the number of REs that can be used for the second-stage SCI is determined, a number of REs/subcarriers in a PSSCH scheduling bandwidth is related to the number of scheduled PRBs and/or a number of REs/subcarriers in one PRB. For example, the number of REs/subcarriers in the PSSCH scheduling bandwidth=the number of scheduled PRBs multiplied by the number of REs/subcarriers in one PRB.

Optionally, the number of physical resource blocks scheduled by the terminal device is determined according to third information, and the third information includes at least one of the following:
a number of subchannels scheduled by the terminal device (for example, n_{subchannel});
a number of interlaces occupied by the subchannel (for example, K);
a number of reference physical resource blocks occupied by the interlace (for example, n_{reference});
a number of physical resource blocks occupied by the interlace (for example, n_{interface}); and
a second coefficient, where the second coefficient is used for indicating a scaling ratio of a resource used for sidelink transmission in one slot (for example, S).

In an example, the number of physical resource blocks scheduled by the terminal device is n_{PRB}=n_{subchannel}·K·n_{reference} or n_{PRB}=n_{subchannel}·K·n_{interface}·S.

Optionally, the number of reference physical resource blocks occupied by the interlace is determined according to fourth information, and the fourth information includes at least one of the following:
A1. a subcarrier spacing;
A2. a guardband configuration;
A3. a resource block set;
A4. a mapping manner of the second-stage sidelink control information;
A5. a first indication, where the first indication is used for indicating the number of reference physical resource blocks occupied by the interlace;
A6. a number of reference physical resource blocks occupied by an interlace configured by at least one of a protocol, a network side device, and the terminal device; and
A7. in interlaces occupied by each subchannel scheduled by the terminal device, a minimum value, a maximum value, or an average value in numbers of reference physical resource blocks occupied by the interlaces.

For item A1, for example, if the subcarrier spacing is 15 KHz, the number n_{reference} of reference physical resource blocks occupied by the interlace is 10 PRBs; or if the subcarrier spacing is 30 KHZ, n_{reference} is 5 PRBs.

For item A2, for example, if the terminal device configures a guardband, and the number n_{reference} of reference physical resource blocks occupied by interlace is N1 PRBs; or if the terminal device configures no guardband, n_{reference} is N2 PRBs. N1 and N2 are both natural numbers, and N1 and N2 may be the same or may be different.

For item A3, for example, the number n_{reference} of reference physical resource blocks occupied by the interlace is an average number obtained by dividing a sum of a number of PRBs of a resource block set (SB set) and a number of PRBs of the guardband by an interlace number. If a quotient of (the number of PRBs of the SB set+the number of PRBs of the guardband)/the interlace number is not an integer, rounding up or down may be performed.

For item A4, for example, if the second-stage SCI is not mapped on the guardband, the number n_{reference} of reference physical resource blocks occupied by the interlace is N3 PRBs; or if the second-stage SCI is mapped on the guardband, n_{reference} is N4 PRBs. For another example, if the second-stage SCI is not mapped on the guardband, n_{reference} is an average number obtained by dividing the PRB number of the RB set by the interlace number. If a quotient of the PRB number of the RB set by the interlace number is not an integer, rounding up or down may be performed. N3 and N4 are both natural numbers, and N3 and N4 may be the same or may be different.

It may be understood that the first indication may be indicated by SCI/DCI.

Optionally, the second coefficient is determined according to the number of reference physical resource blocks occupied by the interlace.

In an example, at least one of a protocol, a network side device, and a terminal device may configure a corresponding second coefficient according to the number of reference physical resource blocks occupied by the interlace. For example, if reference PRBs occupied by one interlace are 11 PRBs, a corresponding second coefficient may be S1; or if the reference PRBs occupied by one interlace is 10 PRBs, a corresponding second coefficient may be S2. S1 and S2 are both positive numbers, and S1 and S2 may be the same or may be different.

In another example, the second coefficient may be determined according to a ratio of the number of reference PRBs occupied by the interlace to the number of PRBs occupied by the interlace. For example, the number of PRBs occupied by one interlace is 11 PRBs, and if the number of reference PRBs occupied by the interlace is 11 PRBs, a corresponding second coefficient may be 1; or if the number of reference PRBs occupied by the interlace is 110 PRBs, a corresponding second coefficient may be 10/11.

It may be understood that the number of PRBs occupied by one interlace may be predefined in a protocol, or may be configured by a network side device or a terminal device.

Optionally, the physical resource block scheduled by the terminal device is determined according to fifth information, and the fifth information includes at least one of the following:
a reference resource scheduled by the terminal device;
a number of reference physical resource blocks occupied by the subchannel; and
a third coefficient, where the third coefficient is used for indicating a scaling ratio of a resource used for sidelink transmission in one slot.

In an optional embodiment of this application, the reference resource scheduled by the terminal device meets a first condition, and the first condition includes at least one of the following:
a start resource and/or an end resource of the reference resource scheduled by the terminal device includes or does not include a subchannel overlapping a guardband; and
the reference resource scheduled by the terminal device includes or does not include a resource in a guardband and/or a rest resource in a resource set, where the rest resource in the resource set is a resource that is in the resource set and that is insufficient to form one subchannel.

It should be noted that a third indication may be introduced to indicate whether a start resource and/or an end resource of the reference resource scheduled by the terminal device includes a subchannel overlapping a guardband and/or a number of subchannels overlapping the guardband included in the start resource and/or the end resource of the reference resource scheduled by the terminal device. For example, the foregoing content may be indicated by using SCI.

It should be noted that a fourth indication may be introduced to indicate whether the scheduled reference resource includes a resource of a guardband and/or a rest resource in a resource set and/or the scheduled reference resource includes the resource of the guardband and/or a number of rest resources in the resource set or a number of physical resource blocks. For example, the content may be indicated by using SCI.

It may be understood that, in this embodiment of this application, that the start resource and/or the end resource of the reference resource scheduled by the terminal device overlap the guardband may be that the start resource and/or the end resource of the reference resource scheduled by the terminal device completely or partially overlap the guardband.

It may be understood that, in this embodiment of this application, the start resource and/or the end resource of the reference resource scheduled by the terminal may be a start subchannel and/or an end subchannel of the reference resource scheduled by the terminal.

Optionally, the number of physical resource blocks scheduled by the terminal device includes at least one of the following:
if the start resource and/or the end resource of the reference resource scheduled by the terminal device does not include a subchannel overlapping a guardband, the number of physical resource blocks scheduled by the terminal device is equal to a first value, where the first value is a product of the number of subchannels scheduled by the terminal device and the number of reference physical resource blocks occupied by the subchannel;
if the reference resource scheduled by the terminal device includes a resource of a guardband, the number of physical resource blocks scheduled by the terminal device is a difference between the first value and a second value, where the second value is a number of physical resource blocks that include a guardband and that are in the reference resource scheduled by the terminal device;
if the reference resource scheduled by the terminal device does not include a resource of a guardband, the number of physical resource blocks scheduled by the terminal device is the first value;
if the start resource and/or the end resource of the reference resource scheduled by the terminal device includes a subchannel overlapping a guardband, the number of physical resource blocks scheduled by the terminal device includes at least one of the following:
a difference between the first value and a third value, where the third value is a number of physical resource blocks occupied by a part that overlaps the guardband and that is of the subchannel that is in the reference resource scheduled by the terminal device and that overlaps the guardband;
a product of a fourth value and the number of reference physical resource blocks occupied by the subchannel, where the fourth value is a difference between the number of subchannels scheduled by the terminal device and a number of subchannels that are in the reference resource scheduled by the terminal device and that overlap the guardband; and
the first value.

In an optional embodiment of this application, the number of physical resource blocks scheduled by the terminal device includes at least one of the following:
if the start resource and/or the end resource of the reference resource scheduled by the terminal device does not include a subchannel overlapping a guardband, and if the reference resource scheduled by the terminal device does not include a resource of a guardband, the number of physical resource blocks scheduled by the terminal device is the first value; or
if the start resource and/or the end resource of the reference resource scheduled by the terminal device does not include a subchannel overlapping a guardband, and if the reference resource scheduled by the terminal device includes a resource of a guardband, the number of physical resource blocks scheduled by the terminal device is a difference between the first value and a second value, where the second value is a number of physical resource blocks that include a guardband and that are in the reference resource scheduled by the terminal device.

Optionally, the number of physical resource blocks scheduled by the terminal device includes at least one of the following:
if the reference resource scheduled by the terminal device does not include a resource of a guardband and/or a rest resource in a resource set, the number of physical resource blocks scheduled by the terminal device is equal to a first value, where the first value is a product of the number of subchannels scheduled by the terminal device and the number of reference physical resource blocks occupied by the subchannel;
if the reference resource scheduled by the terminal device includes the resource of the guardband and/or the rest resource in the resource set, the number of physical resource blocks scheduled by the terminal device is equal to a sum of the first value and a fifth value, where the fifth value is a number of physical resource blocks that include the resource of the guardband and/or the rest resource in the resource set and that are in the reference resource scheduled by the terminal device;
if the second-stage sidelink control information is not mapped on the resource of the guardband and/or the rest resource in the resource set, the number of physical resource blocks scheduled by the terminal device is equal to the first value; and
if the reference resource scheduled by the terminal device includes the resource of the guardband, the number of physical resource blocks scheduled by the terminal device is equal to a sum of the first value and a sixth value, where the sixth value is a number of physical resource blocks that are in the resource of the guardband included in the reference resource scheduled by the terminal device and that do not overlap the subchannel scheduled by the terminal device.

Optionally, in a case that the second-stage SCI is not mapped on the guardband, if the start resource and/or the end resource of the reference resource scheduled by the terminal device includes a subchannel overlapping a guardband, the number of physical resource blocks scheduled by the terminal device includes at least one of the following:
a difference between the first value and a third value, where the third value is a number of physical resource blocks occupied by a part that overlaps the guardband and that is of the subchannel that is in the reference resource scheduled by the terminal device and that overlaps the guardband;
a product of a fourth value and the number of reference physical resource blocks occupied by the subchannel, where the fourth value is a difference between the number of subchannels scheduled by the terminal device and a number of subchannels that are in the reference resource scheduled by the terminal device and that overlap the guardband; and
the first value.

Alternatively, in a case that the second-stage SCI is not mapped on the guardband, if the start resource and/or the end resource of the reference resource scheduled by the terminal device does not include a subchannel overlapping a guardband, the number of physical resource blocks scheduled by the terminal device is equal to a first value, where the first value is a product of the number of subchannels scheduled by the terminal device and the number of reference physical resource blocks occupied by the subchannel.

Optionally, the resource of the guardband and/or the rest resource in the resource set is determined as at least one subchannel.

It may be understood that, the resource of the guardband and/or the rest resource in the resource set are considered as at least one virtual subchannel. When the scheduled reference resource is determined, the resource of the guardband and/or the rest resource in the resource set may be determined according to a number of physical resource blocks occupied by the virtual subchannel.

Optionally, the resource of the at least one guardband and/or the rest resource in the at least one resource set are determined as at least one subchannel.

It may be understood that, resources of a plurality of guardbands and/or rest resources in a plurality of resource sets are considered as at least one virtual subchannel. When the scheduled reference resource is determined, the resources of the plurality of guardbands and/or the rest resources in the plurality of resource sets may be determined according to a number of physical resource blocks occupied by the virtual subchannel.

Optionally, the number of subchannels scheduled by the terminal device further includes a number of subchannels determined based on at least one guardband and/or at least one rest physical resource block.

In an optional embodiment of this application, the number of physical resource blocks scheduled by the terminal device includes at least one of the following:

If the reference resource scheduled by the terminal device includes the resource of the guardband and/or the rest resource in the resource set, the number of subchannels scheduled by the terminal device is a number of scheduled subchannels plus a number of subchannels determined based on at least one guardband and/or at least one rest physical resource block, and the number of physical resource blocks scheduled by the terminal device is a number of reference physical resource blocks occupied by the number of subchannels scheduled by the terminal device.

Optionally, the number of reference physical resource blocks occupied by the subchannel includes at least one of the following:
a number of physical resource blocks occupied by a subchannel that divides a resource block set;
a number of physical resource blocks obtained after physical resource blocks in the resource block set are evenly divided into subchannels scheduled by the terminal device; and
a number of physical resource blocks obtained after physical resource blocks in a first set are evenly divided into the subchannels scheduled by the terminal device, where the first set includes each physical resource block in the resource block set and a physical resource block occupied by a guardband.

It may be understood that if the number obtained through average division is not an integer, rounding up or down may be performed.

Optionally, the third coefficient includes at least one of the following:
if a start resource and/or an end resource of the reference resource scheduled by the terminal device do not include a subchannel overlapping a guardband, the third coefficient is a first preset value;
if the start resource and/or the end resource of the reference resource scheduled by the terminal device include a subchannel overlapping the guardband, the third coefficient is a second preset value;
if the reference resource scheduled by the terminal device does not include a resource of the guardband and/or a rest resource in a resource set, the third coefficient is a third preset value; and
if the reference resource scheduled by the terminal device includes the resource of the guardband and/or the rest resource in the resource set, the third coefficient is a fourth preset value.

For example, if the start resource or the end resource of the reference resource scheduled by the terminal device does not include the subchannel overlapping the guardband, the third coefficient may be S1; or if the start resource or the end resource of the reference resource scheduled by the terminal device includes the subchannel overlapping the guardband, the third coefficient may be S2. If neither the start resource nor the end resource of the reference resource scheduled by the terminal device includes the subchannel overlapping the guardband, the third coefficient may be S1; or if both the start resource and the end resource of the reference resource scheduled by the terminal device include the subchannel overlapping the guardband, the third coefficient may be S2.

For another example, if the start resource of the reference resource scheduled by the terminal device does not include the subchannel overlapping the guardband, the third coefficient may be S3; or if the end resource of the reference resource scheduled by the terminal device does not include the subchannel overlapping the guardband, the third coefficient may be S4.

If the reference resource scheduled by the terminal device does not include the resource of the guardband and/or the rest resource in the resource set, the third coefficient may be S1; or if the reference resource scheduled by the terminal device includes the resource of the guardband and/or the rest resource in the resource set, the third coefficient may be S2. If the start resource and/or the end resource of the reference resource scheduled by the terminal device does not include the subchannel overlapping the guardband, and the reference resource scheduled by the terminal device includes the resource of the guardband and/or the rest resource in the resource set, the third coefficient may be S2. If the start resource and/or the end resource of the reference resource scheduled by the terminal device does not include the subchannel overlapping the guardband, and the reference resource scheduled by the terminal device does not include the resource of the guardband and/or the rest resource in the resource set, the third coefficient may be S3.

It may be understood that, according to different first conditions that are met by the reference resource scheduled by the terminal, a corresponding third coefficient is predefined in a protocol/configured by a network/configured by UE/determined by the UE.

Optionally, the number of physical resource blocks scheduled by the terminal device is a product of the number of subchannels scheduled by the terminal device, the number of reference physical resource blocks occupied by the subchannel, and the third coefficient.

Optionally, the number of physical resource blocks scheduled by the terminal device is equal to a product of the number of subchannels scheduled by the terminal device and the number of reference physical resource blocks occupied by the subchannel.

Optionally, the physical resource block scheduled by the terminal device do not include the guardband and/or the rest physical resource block in the resource set.

Optionally, the second-stage sidelink control information is not mapped on the resource of the guardband and/or the rest resource in the resource set.

Optionally, the first parameter is determined according to sixth information, and the sixth information includes at least one of the following:
B1. a reference symbol number;
B2. a start symbol position;
B3. a second indication, where the second indication is used for indicating a determining manner of the first parameter; and
B4. the first parameter configured by at least one of a protocol, a network side device, and the terminal device.

For item B2, for example, one slot has a plurality of start symbols that can be used for sidelink transmission, and the first parameter may be a symbol length that can be used for sidelink transmission and that is determined based on the first start symbol, a symbol length that can be used for sidelink transmission and that is determined based on the second start symbol, or the like.

For item B3, the second indication may be dynamically indicated by TX UE. For example, the TX UE dynamically indicates that the first parameter is a symbol length that can be used for sidelink transmission and that is determined based on the first start symbol, or a symbol length that can be used for sidelink transmission and that is determined based on the second start symbol. Optionally, the first parameter may be indicated by using SCI.

In an optional embodiment of this application, that the terminal device performs sidelink transmission according to the transport block size and/or the second-stage sidelink control information includes:

Step S11: The terminal device determines a transport block according to the first parameter and monitors a channel corresponding to the transport block, to obtain a monitoring result.

Step S12: The terminal device performs sidelink transmission according to the monitoring result.

In this embodiment of this application, the terminal device may determine a transport block according to the first parameter, and select, according to the monitoring result, an appropriate transport block for sidelink transmission.

For example, the UE prepares TB1 according to the first reference symbol length that is determined based on the first start symbol, and the UE prepares TB2 according to the second reference symbol length that is determined based on the second start symbol. If monitoring succeeds before a moment corresponding to the first start symbol, the UE sends TB1. If monitoring fails before the moment corresponding to the first start symbol and monitoring succeeds before a moment corresponding to the second start symbol, the UE sends TB2.

For another example, the terminal device may prepare a TB according to the first reference symbol length that is determined based on the first start symbol. If monitoring succeeds before the moment corresponding to the first start symbol, the UE sends the TB. If monitoring fails before the moment corresponding to the first start symbol and monitoring succeeds before the moment corresponding to the second start symbol, the UE may send a part of the TB and discard a symbol that is not completely mapped.

Optionally, the transport block in this embodiment of this application may be a transport block of a different hybrid automatic repeat request (HTTP) process.

Optionally, the first parameter includes a first reference symbol length determined based on a first start symbol; and the performing, by the terminal device, sidelink transmission according to the monitoring result includes:

Step S21: The terminal device performs sidelink transmission based on a transport block corresponding to the first reference symbol length if the terminal device successfully monitors before a moment corresponding to the first start symbol.

Step S22: The terminal device performs sidelink transmission based on a transport block in a next slot or a transport block determined according to a next first start symbol if the terminal device fails to monitor before a moment corresponding to the first start symbol and successfully monitors before a moment corresponding to the second start symbol.

Optionally, in a retransmission process, the terminal device may not feed back a TB starting to be transmitted at the second start symbol, or may feed back only a TB starting to be transmitted at the first start symbol, thereby reducing mapping between a mini-slot and a PSFCH occlusion.

Optionally, the terminal device may prepare the TB according to the second reference symbol length that is determined based on the second start symbol, and send the TB according to the monitoring result. If monitoring succeeds before the moment corresponding to the first start symbol, CPE/data padding may be performed for a rest symbol after transmission is completed, so as to facilitate COT sharing or multi slot.

Optionally, a reference symbol length of the transport block is determined according to seventh information, and the seventh information includes at least one of the following:
a traffic type;
a channel busy ratio (CBR);
a channel occupancy ratio (CR);
a channel monitoring result;
a modulation coding scheme (MCS);
a target code rate;
a priority of the transport block; and
a rest packet delay budget (rest PDB).

The traffic type may be a data volume, a delay, reliability, a rate, or the like. For example, for data having a large data volume, the TB may be prepared based on the first reference symbol length determined based on the first start symbol. For data with high reliability, the TB may be prepared based on the second reference symbol length determined based on the second start symbol.

Optionally, that the terminal device performs sidelink transmission according to the monitoring result includes:
Step S31: The terminal device performs rate matching on the transport block according to the first reference symbol length; and/or
Step S32: The terminal device performs rate matching on the transport block according to the second reference symbol length if channel access of the terminal device fails before a moment corresponding to the first start symbol; and
Step S33. The terminal device performs sidelink transmission according to the monitoring result and a transport block after the rate matching.

It may be understood that an interval between the first start symbol and the second start symbol does not exceed a specific preset value, for example, 4 symbols.

In an optional embodiment of this application, the method further includes:

The terminal device performs retransmission based on the monitoring result if an initial transmission resource of the terminal device is a resource determined based on a first start symbol.

Optionally, that the terminal device performs retransmission based on the monitoring result if an initial transmission resource of the terminal device is a resource determined based on a first start symbol includes:

Step S41: The terminal device performs retransmission based on a first resource if channel access of the terminal device succeeds before a moment corresponding to a first start symbol of the first resource in a case that the initial transmission resource of the terminal device is the resource determined based on the first start symbol.

Step S42: The terminal device performs retransmission based on a second resource if channel access of the terminal device succeeds before a moment corresponding to a second start symbol of the first resource.

The first resource and the initial transmission resource include a same transport block, the second resource includes a transport block that belongs to a different hybrid automatic repeat request procedure from the initial transmission resource, and/or a transport block that belongs to a different redundancy version from the initial transmission resource.

In an example, if the UE successfully accesses a channel on a second start symbol of a retransmission resource (that is, the first resource in this application), the UE may select the first resource (a retransmission TB) or the second resource (a new transmission TB) according to at least one of the following:
an MCS, for example, if an MCS of the retransmission TB is excessively high, the UE selects a new transmission TB. Otherwise, the UE selects the retransmission TB; and
a code rate, for example, if a code rate of the retransmission TB is excessively high, the UE selects a new transmission TB. Otherwise, the UE selects the retransmission TB.

Optionally, the first resource includes at least one of the following:
if the initial transmission resource of the terminal device is the resource determined based on the first start symbol, the terminal device determines that the first resource is the resource determined based on the first start symbol; or
if the initial transmission resource of the terminal device is a resource determined based on the second start symbol, the terminal device determines that the first resource is the resource determined based on the second start symbol.

If the initial transmission resource of the UE is a resource determined based on the first start symbol/a slot-based resource, when selecting the first resource, the UE preferentially selects/only selects the resource determined based on the first start symbol/the slot-based resource.

If the initial transmission resource of the UE is a resource determined based on the second start symbol/a mini slot-based resource, when selecting the first resource, the UE preferentially selects/only selects the resource determined based on the second start symbol/the mini slot-based resource.

Optionally, the first resource includes a resource that is the same as an interlace and/or a guardband included in the initial transmission resource.

The following describes the sidelink transmission method provided in this application with reference to a specific sidelink transmission process.

FIG. 6 is a schematic structural diagram of a slot. As shown in FIG. 6, if a resource pool includes a slot that is used for PSCCH/PSSCH transmission and that has two start symbol positions, it is set that sl-LengthSymbols represents a number of symbols that can be used for sidelink transmission in one slot, sl-StartSymbol1 represents a first start symbol position (that is, a symbol 0 in FIG. 6), and sl-StartSymbol2 represents a second start symbol position (that is, a symbol 7 in FIG. 6).

In an optional embodiment of this application, calculation of the TBS may include the following steps:

1. Calculate a number of available REs in one slot/a number of REs occupied by a PSSCH:

$${N}_{RE} = {N}_{RE}^{′} \cdot {n}_{PRB} - {N}_{RE}^{SCI , 1} - {N}_{RE}^{SCI , 2} \qquad ( 1 )$$

where n_{PRB} is a number of PRBs occupied by the PSSCH;

$${N}_{RE}^{SCI , 1}$$

is a number of REs occupied by first-stage SCI, and may specifically include REs occupied by a PSCCH and a DMRS of the PSCCH; and

$${N}_{RE}^{SCI , 2}$$

is a number of RES occupied by second-stage SCI, and the second-stage SCI is used for storing information of receive UE.

N_{RE}′ is a number of REs that can be used for a PSSCH in one PRB, and may be specifically represented as:

$${N}_{RE}^{′} = {N}_{sc}^{RB} ( {N}_{symb}^{sh} - {N}_{symb}^{PSFCH} - {N}_{symb}^{reference} ) - {N}_{oh}^{PRB} - {N}_{RE}^{DMRS} \qquad ( 8 )$$

where

$${N}_{sc}^{RB} = 12$$

represents a number of subcarriers in one PRB.

$${N}_{symbol}^{sh} = sl - LengthSymbols ‐ 2$$

represents a number of symbols that can be used for sidelink in one slot, and does not include a last GP symbol and a first symbol used for AGC.

$${N}_{symb}^{PSFCH} = 0$$

or 3, is a number of symbols occupied by a PSFCH, and may be determined according to a “PSFCH overhead indication” field indication in the first-stage SCI.

$${N}_{symb}^{reference} = 0$$

or si-StartSymbol2-sl-StartSymbol1, determined according to a “reference symbol length indication” field indication in the first-stage SCI.

$${N}_{oh}^{PRB}$$

is overheads provided for configuring sl-X-Overhead by a high layer and is used for indicating numbers of REs occupied by a PT-RS and a CSI-RS.

$${N}_{RE}^{DMRS}$$

is an average number of DMRS REs in one slot, and is determined according to Table 8.1.3.2-1 and sl-PSSCH-DMRS-TimePattern configured by a high layer.

2. Calculate an information intermediate number:

$${N}_{info} = {N}_{RE} \cdot R \cdot {Q}_{m} \cdot υ \qquad ( 3 )$$

When N_{info}≤3824, step 3 is used; otherwise, step 4 is used.

3. When N_{info}≤3824, an intermediate number is quantized, where n=max(3,└log(N_{info})┘−6). A latest TBS not less than N_{info}′ is found in an index table of a TBS shown in FIG. 3.

4. When N_{info}>3824, the intermediate number

$${N}_{info}^{′} = max ( 3840 , {2}^{″} \times round ( \frac{{N}_{info} - 24}{{2}^{″}} ) )$$

is quantized, where n=└log₂(N_{info}−24)┘−5.

And/or, a number of REs or a number of coded modulation symbols occupied by the second-stage SCI may be calculated according to the following formula:

$${Q}_{SCI 2}^{′} = min \{ ⌈ \frac{( {O}_{SCI 2} + {L}_{SCI 2} ) \cdot {β}_{offset}^{SCI 2}}{{Q}_{m}^{SCI 2} \cdot R} ⌉ , ⌈ α {\sum }_{l = 0}^{{N}_{symbol}^{PSSCH} - 1} {M}_{sc}^{SCI 2} ( l ) ⌉ \} + γ \qquad ( 4 )$$

where O_{SCI2} represents a number of second-stage SCI information bits, and is determined by a format of the second-stage SCI.

L_{SCI2} represents a CRC length of the second-stage SCI, and is 24 bits.

$${β}_{offset}^{SCI 2}$$

is a code rate onset of the second-stage SCI, and is indicated by using the first-stage SCI.

$${Q}_{m}^{SCI 2} = 2$$

is a modulation order of the second-stage SCI.

R is a code rate corresponding to an MCS index indicated in a “MCS” indication field in the first-stage SCI.

$${M}_{sc}^{SCI 2} ( l ) = {M}_{sc}^{PSSCH} ( l ) - {M}_{sc}^{PSSCH} ( l )$$

represents a number of REs that can be used to map the second-stage SCI on a first OFDM symbol.

$${M}_{sc}^{PSSCH} ( l )$$

represents a number of REs in a transmit bandwidth of the PSSCH, and

$${M}_{sc}^{PSSCH} ( l )$$

is a number of REs used for the PSCCH on a first OFDM symbol.

$$l = 0 , 1 , 2 ⋯ , {N}_{symbol}^{PSSCH} - 1 {N}_{symbol}^{PSSCH} = {N}_{symb}^{sh} - {N}_{symb}^{PSFCH} - {N}_{symb}^{reference} ,$$

where

$${N}_{symb}^{sh} = sl - lengthSymbols - 2$$

represents OFDM symbols other than the first AGC symbol and the last GP symbol that can be used for sidelink in a current slot; and

$${N}_{symb}^{PSFCH} = 0$$

or 3, is a number of symbols occupied by the PSFCH, and is determined according to a “PSFCH overhead indication” field indication in the first-stage SCI.

$${N}_{symb}^{reference} = 0$$

or si-StartSymbol2-sl-StartSymbol1, determined according to a “reference symbol length indication” field indication in the first-stage SCI.

A value of γ is 0 to 11, representing a number of REs rest in a PRB in which a last second-stage SCI modulation symbol is located, and the parameter is used to ensure that a resource occupied by the second-stage SCI is an integer number of PRBs.

α is maximum spectral efficiency of the second-stage SCI configured for RRC.

In another optional embodiment of this application, the calculation process of the TBS may also be the following steps:

1. Calculate a number of available REs in one slot and/or a number of REs occupied by a PSSCH:

$${N}_{RE} = {N}_{RE}^{′} \cdot {n}_{PRB} - {N}_{RE}^{SCI , 1} - {N}_{RE}^{SCI , 2} \qquad ( 1 )$$

where n_{PRB} is a number of PRBs occupied by the PSSCH;

$${N}_{RE}^{SCI , 1}$$

is a number of REs occupied by first-stage SCI, and may specifically include REs occupied by a PSCCH and a DMRS of the PSCCH; and

$${N}_{RE}^{SCI , 2}$$

is a number of REs occupied by second-stage SCI, and the second-stage SCI is used for storing information of receive UE.

N_{RE}′ is a number of REs that can be used for a PSSCH in one PRB, and may be specifically represented as:

$${N}_{RE}^{′} = {N}_{sc}^{RB} ( {N}_{symb}^{sh} - {N}_{symb}^{PSFCH} ) - {N}_{oh}^{PRB} - {N}_{RE}^{DMRS} \qquad ( 2 )$$

where

$${N}_{sc}^{RB} = 12$$

represents a number of subcarriers in one PRB.

$${N}_{symb}^{sh} = sl - LengthSymbols - 2$$

represents a number of symbols that can be used for sidelink in one slot, and does not include a last GP symbol and a first symbol used for AGC.

$${N}_{symb}^{PSFCH} = 0$$

or 3, is a number of symbols occupied by a PSFCH, and may be determined according to a “PSFCH overhead indication” field indication in the first-stage SCI.

$${N}_{oh}^{PRB}$$

is overheads provided for configuring sl-X-Overhead by a high layer and is used for indicating numbers of REs occupied by a PT-RS and a CSI-RS.

$${N}_{RE}^{DMRS}$$

is an average number of DMRS REs in one slot, and is determined according to Table 8.1.3.2-1 and sl-PSSCH-DMRS-TimePattern configured by a high layer.

2. Calculate an information intermediate number:

$${N}_{info} = {N}_{RE} \cdot R \cdot {Q}_{m} \cdot v \cdot S \qquad ( 9 )$$

S=1 or

$$1 - \frac{sl - StartSymbol 2 + sl - StartSymbol 1}{sl - LengthSymbols} ,$$

determined according to a “reference symbol length indication” field indication in the first-stage SCI.

When N_{info}≤3824, step 3 is used; otherwise, step 4 is used.

3. When N_{info}≤3824, an intermediate number is quantized, where n=max(3,└log₂(N_{info})┘−6). A latest TBS not less than N_{info}′ is found in an index table of a TBS shown in FIG. 3.

4. When N_{info}>3824, the intermediate number

$${N}_{info}^{′} = max ( 3840 , {2}^{″} \times round ( \frac{{N}_{info} - 24}{{2}^{″}} ) )$$

is quantized, where n=└log₂(N_{info}−24)┘−5.

And/or, a number of REs or a number of coded modulation symbols occupied by the second-stage SCI may be calculated according to the following formula:

$${Q}_{SCI 2}^{′} = min \{ ⌈ \frac{{O}_{SCI 2} + {L}_{SCI 2}}{{Q}_{M}^{SCI 2} \cdot R} ⌉ , ⌈ S \cdot α {\sum }_{l = 0}^{{N}_{symbol}^{PSSCH} - 1} {M}_{SC}^{SCI 2} ( l ) ⌉ \} + γ \qquad ( 10 )$$

S=1 or

$$1 - \frac{sl - StartSymbol 2 + sl - StartSymbol 1}{sl - LengthSymbols} ,$$

determined according to a “reference symbol length indication” field indication in the first-stage SCI.

In still another optional embodiment of this application, the calculation process of the TBS may include the following steps:

$${N}_{RE} = {N}_{RE}^{′} \cdot {n}_{PRB} - {N}_{RE}^{SCI , 1} - {N}_{RE}^{SCI , 2} \qquad ( 1 )$$

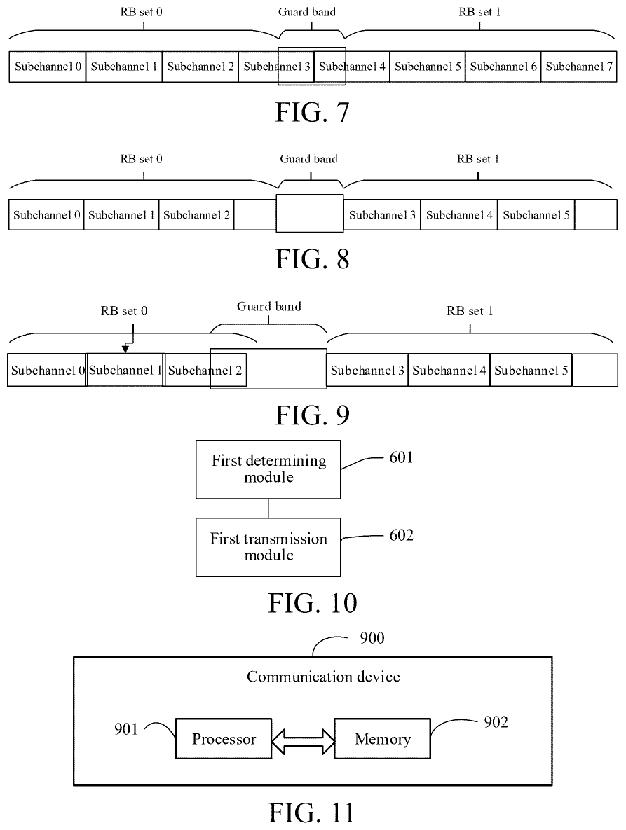

n_{PRB} is determined according to the schematic structural diagram of the slot shown in FIG. 7.

As shown in FIG. 7, if the UE does not support use of a part of a subchannel, for example, a part of subchannel 3/4 that partially overlaps the guardband cannot be used, and no additional indication is needed, n_{PRB}=a number of scheduled subchannels×a reference PRB occupied by one subchannel.

If use of a part of a subchannel is supported, for example, only a part of the subchannel 3/4 that does not overlap the guardband can be used, and if the first-stage SCI indicates that a start/end subchannel of a scheduled reference resource does not include a subchannel (for example, the subchannel 3 or the subchannel 4) that overlaps or partially overlaps the guardband, n_{PRB}=a number of scheduled subchannels×a reference PRB occupied by one subchannel. If the first-stage SCI indicates that the start/end subchannel of the scheduled reference resource includes a subchannel (for example, includes subchannel 3) that overlaps or partially overlaps the guardband, n_{PRB}=a number of scheduled subchannels×a reference PRB occupied by one subchannel−a number of PRBs that are in subchannel 3 and that overlap the guardband.

Referring to a schematic structural diagram of a slot shown in FIG. 8, if the guardband and the rest PRB are considered as a whole, and if the first-stage SCI indicates that the reference resource does not include the guardband, n_{PRB}=a number of scheduled subchannels×a reference PRB occupied by one subchannel; or if the first-stage SCI indicates that the reference resource includes the resource of the guardband, n_{PRB}=a number of scheduled subchannels×a reference PRB occupied by one subchannel+PRB number of guardband and rest PRB.

Alternatively, the guardband and the rest PRB may be considered as one subchannel. If the first-stage SCI indicates that the reference resource does not include the guardband, n_{PRB}=a number of scheduled subchannels×a reference PRB occupied by one subchannel; or if the first-stage SCI indicates that the reference resource includes (one) guardband (if there are M guardbands, Mis added), n_{PRB}=(a number of scheduled subchannels+1)×a reference PRB occupied by one subchannel.

Referring to a schematic structural diagram of a slot shown in FIG. 9, if use of a part of a subchannel is not supported, for example, a part of the subchannel 2 that partially overlaps the guardband cannot be used. If the first-stage SCI indicates that the scheduled reference resource does not include the guardband, n_{PRB}=a number of scheduled subchannels×a reference PRB occupied by one subchannel; or if the first-stage SCI indicates that the scheduled reference resource includes the resource of the guardband, n_{PRB}=a number of scheduled subchannels×a reference PRB occupied by one subchannel+a number of PRBs that are in the guardband and that do not overlap the subchannel.

If use of a part of a subchannel is supported, for example, the subchannel 2 partially overlaps the guardband, and a part of the subchannel 2 that does not overlap the guardband can be used. If the first-stage SCI indicates that the start/end subchannel of the scheduled reference resource includes a subchannel overlapping or partially overlapping the guardband, n_{PRB}=a number of scheduled subchannels×a reference PRB occupied by one subchannel+a number of PRBs that are in the guardband and that do not overlap the subchannel; or if the first-stage SCI indicates that the start/end subchannel of the scheduled reference resource does not include a subchannel overlapping or partially overlapping the guardband, and indicates that the scheduled reference resource includes the resource of the guardband, n_{PRB}=a number of scheduled subchannels×a reference PRB occupied by one subchannel+a number of PRBs that are in the guardband and that do not overlap the subchannel; or if the first-stage SCI indicates that the start/end subchannel of the scheduled reference resource does not include a subchannel overlapping or partially overlapping the guardband, and indicates that the reference resource does not include the guardband, n_{PRB}=a number of scheduled subchannels×a reference PRB occupied by one subchannel.

In conclusion, the embodiment of this application provides a sidelink transmission method. The terminal device determines the transport block size and/or the second-stage SCI according to the first information and performs sidelink transmission, to ensure consistency of transmission resources during initial transmission and retransmission, thereby improving effectiveness of sidelink transmission and improving resource utilization.

The sidelink transmission method provided in the embodiment of this application may be performed by a sidelink transmission apparatus. In the embodiment of this application, by using an example in which the sidelink transmission apparatus performs the sidelink transmission method, the sidelink transmission apparatus provided in the embodiment of this application is described.

According to a second aspect, an embodiment of this application provides a sidelink transmission apparatus. FIG. 10 is a structural block diagram of a sidelink transmission apparatus according to an embodiment of this application. The apparatus may be applied to a terminal device. As shown in FIG. 10, the apparatus may specifically include:
a first determining module 601, configured to determine a transport block size and/or second-stage sidelink control information according to first information; and
a first transmission module 602, configured to perform sidelink transmission according to the transport block size and/or the second-stage sidelink control information.

The first information includes at least one of the following:
a first parameter, where the first parameter is used for indicating time domain resource information used for sidelink transmission in one slot;
a first coefficient, where the first coefficient is used for indicating a scaling ratio of a resource used for sidelink transmission in one slot; and
information about physical resource blocks scheduled by the terminal device.

Optionally, the first determining module includes:
a first determining submodule, configured to determine a scheduling symbol number according to second information; and
a second determining submodule, configured to determine the transport block size and/or the second-stage sidelink control information according to the scheduling symbol number;
where the second information includes at least one of the following:
a first parameter, where the first parameter is used for indicating time domain resource information used for sidelink transmission in one slot;
an automatic gain control symbol number, where the automatic gain control symbol number is used for indicating a number of symbols occupied by automatic gain control in one slot; and
a guard symbol number, where the guard symbol number is used for indicating a number of symbols occupied by a guard period.

Optionally, the first coefficient is determined according to the first parameter.

Optionally, the first determining module includes:
a third determining submodule, configured to calculate a difference between a scheduling symbol number and a second parameter, where the scheduling symbol number is used for indicating a number of symbols used for sidelink transmission in one slot, and the second parameter is used for indicating a sidelink transmission overhead in one slot; and
a fourth determining submodule, configured to determine the transport block size and/or the second-stage sidelink control information according to the difference between the scheduling symbol number and the second parameter.

The second parameter includes a third parameter and/or a physical sidelink feedback channel PSFCH overhead, the third parameter is determined according to the first parameter, and the PSFCH overhead is determined according to PSFCH configuration information and/or the first parameter.

Optionally, the information about the physical resource block scheduled by the terminal device includes at least one of the following:
a number of physical resource blocks scheduled by the terminal device;
a number of resource elements included in the physical resource block;
a number of resource elements occupied by first-stage sidelink control information; and
a number of resource elements occupied by the second-stage sidelink control information.

Optionally, the number of physical resource blocks scheduled by the terminal device is determined according to third information, and the third information includes at least one of the following:
a number of subchannels scheduled by the terminal device;
a number of interlaces occupied by the subchannel;
a number of reference physical resource blocks occupied by the interlace;
a number of physical resource blocks occupied by the interlace; and
a second coefficient, where the second coefficient is used for indicating a scaling ratio of a resource used for sidelink transmission in one slot.

Optionally, the number of reference physical resource blocks occupied by the interlace is determined according to fourth information, and the fourth information includes at least one of the following:
a subcarrier spacing;
a guardband configuration;
a resource block set;
a mapping manner of the second-stage sidelink control information;
a first indication, where the first indication is used for indicating the number of reference physical resource blocks occupied by the interlace;
a number of reference physical resource blocks occupied by an interlace configured by at least one of a protocol, a network side device, and the terminal device; and
in interlaces occupied by each subchannel scheduled by the terminal device, a minimum value, a maximum value, or an average value in numbers of reference physical resource blocks occupied by the interlaces.

Optionally, the second coefficient is determined according to the number of reference physical resource blocks occupied by the interlace.

Optionally, the physical resource block scheduled by the terminal device is determined according to fifth information, and the fifth information includes at least one of the following:
a reference resource scheduled by the terminal device;
a number of reference physical resource blocks occupied by the subchannel; and
a third coefficient, where the third coefficient is used for indicating a scaling ratio of a resource used for sidelink transmission in one slot.

Optionally, the reference resource scheduled by the terminal device meets a first condition, and the first condition includes at least one of the following:
a start resource and/or an end resource of the reference resource scheduled by the terminal device includes or does not include a subchannel overlapping a guardband; and
the reference resource scheduled by the terminal device includes or does not include a resource in a guardband and/or a rest resource in a resource set, where the rest resource in the resource set is a resource that is in the resource set and that is insufficient to form one subchannel.

Optionally, the number of physical resource blocks scheduled by the terminal device includes at least one of the following:
if the start resource and/or the end resource of the reference resource scheduled by the terminal device does not include a subchannel overlapping a guardband, the number of physical resource blocks scheduled by the terminal device is equal to a first value, where the first value is a product of the number of subchannels scheduled by the terminal device and the number of reference physical resource blocks occupied by the subchannel;
if the reference resource scheduled by the terminal device includes a resource of a guardband, the number of physical resource blocks scheduled by the terminal device is a difference between the first value and a second value, where the second value is a number of physical resource blocks that include a guardband and that are in the reference resource scheduled by the terminal device;
if the reference resource scheduled by the terminal device does not include a resource of a guardband, the number of physical resource blocks scheduled by the terminal device is the first value;
if the start resource and/or the end resource of the reference resource scheduled by the terminal device includes a subchannel overlapping a guardband, the number of physical resource blocks scheduled by the terminal device includes at least one of the following:
a difference between the first value and a third value, where the third value is a number of physical resource blocks occupied by a part that overlaps the guardband and that is of the subchannel that is in the reference resource scheduled by the terminal device and that overlaps the guardband;
a product of a fourth value and the number of reference physical resource blocks occupied by the subchannel, where the fourth value is a difference between the number of subchannels scheduled by the terminal device and a number of subchannels that are in the reference resource scheduled by the terminal device and that overlap the guardband; and
the first value.

Optionally, the number of physical resource blocks scheduled by the terminal device includes at least one of the following:
if the reference resource scheduled by the terminal device does not include a resource of a guardband and/or a rest resource in a resource set, the number of physical resource blocks scheduled by the terminal device is equal to a first value, where the first value is a product of the number of subchannels scheduled by the terminal device and the number of reference physical resource blocks occupied by the subchannel;
if the reference resource scheduled by the terminal device includes the resource of the guardband and/or the rest resource in the resource set, the number of physical resource blocks scheduled by the terminal device is equal to a sum of the first value and a fifth value, where the fifth value is a number of physical resource blocks that include the resource of the guardband and/or the rest resource in the resource set and that are in the reference resource scheduled by the terminal device;
if the second-stage sidelink control information is not mapped on the resource of the guardband and/or the rest resource in the resource set, the number of physical resource blocks scheduled by the terminal device is equal to the first value; and
if the reference resource scheduled by the terminal device includes the resource of the guardband, the number of physical resource blocks scheduled by the terminal device is equal to a sum of the first value and a sixth value, where the sixth value is a number of physical resource blocks that are in the resource of the guardband included in the reference resource scheduled by the terminal device and that do not overlap the subchannel scheduled by the terminal device.

Optionally, the resource of the guardband and/or the rest resource in the resource set includes at least one subchannel.

Optionally, the number of subchannels scheduled by the terminal device further includes a number of subchannels determined based on at least one guardband and/or at least one rest physical resource block.

Optionally, the number of reference physical resource blocks occupied by the subchannel includes at least one of the following:
a number of physical resource blocks occupied by a subchannel that divides a resource block set;
a number of physical resource blocks obtained after physical resource blocks in the resource block set are evenly divided into subchannels scheduled by the terminal device; and
a number of physical resource blocks obtained after physical resource blocks in a first set are evenly divided into the subchannels scheduled by the terminal device, where the first set includes each physical resource block in the resource block set and a physical resource block occupied by a guardband.

Optionally, the third coefficient includes at least one of the following:
if a start resource and/or an end resource of the reference resource scheduled by the terminal device do not include a subchannel overlapping a guardband, the third coefficient is a first preset value;
if the start resource and/or the end resource of the reference resource scheduled by the terminal device include a subchannel overlapping the guardband, the third coefficient is a second preset value;
if the reference resource scheduled by the terminal device does not include a resource of the guardband and/or a rest resource in a resource set, the third coefficient is a third preset value; and
if the reference resource scheduled by the terminal device includes the resource of the guardband and/or the rest resource in the resource set, the third coefficient is a fourth preset value.

Optionally, the number of physical resource blocks scheduled by the terminal device is a product of the number of subchannels scheduled by the terminal device, the number of reference physical resource blocks occupied by the subchannel, and the third coefficient.

Optionally, the number of physical resource blocks scheduled by the terminal device is equal to a product of the number of subchannels scheduled by the terminal device and the number of reference physical resource blocks occupied by the subchannel.

Optionally, the second-stage sidelink control information is not mapped on the resource of the guardband and/or the rest resource in the resource set.

Optionally, the first parameter is determined according to sixth information, and the sixth information includes at least one of the following:
a reference symbol number;
a start symbol position;
a second indication, where the second indication is used for indicating a determining manner of the first parameter; and
the first parameter configured by at least one of a protocol, a network side device, and the terminal device.

Optionally, the first transmission module includes:
a monitoring submodule, configured to: determine a transport block according to the first parameter and monitor a channel corresponding to the transport block, to obtain a monitoring result; and
a transmission submodule, configured to perform sidelink transmission according to the monitoring result.

Optionally, the first parameter includes a first reference symbol length determined based on a first start symbol, and the transmission submodule includes:
a first transmission unit, configured to perform sidelink transmission based on a transport block corresponding to the first reference symbol length if the terminal device successfully monitors before a moment corresponding to the first start symbol; and
a second transmission unit, configured to perform sidelink transmission based on a transport block in a next slot or a transport block determined according to a next first start symbol if the terminal device fails to monitor before a moment corresponding to the first start symbol and successfully monitors before a moment corresponding to the second start symbol.

Optionally, a reference symbol length of the transport block is determined according to seventh information, and the seventh information includes at least one of the following:
a traffic type;
a channel busy ratio;
a channel occupancy ratio;
a channel monitoring result;
a modulation coding scheme;
a target code rate;
a priority of the transport block; and
a rest packet delay budget.

Optionally, the transmission submodule includes:
a first rate matching unit, configured to perform rate matching on the transport block according to the first reference symbol length; and/or
a second rate matching unit, configured to: perform rate matching on the transport block according to the second reference symbol length if channel access of the terminal device fails before a moment corresponding to the first start symbol; and
a third transmission unit, configured to perform sidelink transmission according to the monitoring result and a transport block after the rate matching.

Optionally, the apparatus further includes:
a second transmission module, configured to perform retransmission based on the monitoring result if an initial transmission resource of the terminal device is a resource determined based on a first start symbol.

Optionally, the second transmission module includes:
a first retransmission submodule, configured to: perform retransmission based on a first resource if channel access of the terminal device succeeds before a moment corresponding to a first start symbol of the first resource in a case that the initial transmission resource of the terminal device is the resource determined based on the first start symbol; and
a second retransmission submodule, configured to: perform retransmission based on a second resource if channel access of the terminal device succeeds before a moment corresponding to a second start symbol of the first resource.

The first resource and the initial transmission resource include a same transport block, the second resource includes a transport block that belongs to a different hybrid automatic repeat request procedure from the initial transmission resource, and/or a transport block that belongs to a different redundancy version from the initial transmission resource.

Optionally, the first resource includes at least one of the following:
if the initial transmission resource of the terminal device is the resource determined based on the first start symbol, the terminal device determines that the first resource is the resource determined based on the first start symbol; or
if the initial transmission resource of the terminal device is a resource determined based on the second start symbol, the terminal device determines that the first resource is the resource determined based on the second start symbol.

Optionally, the first resource includes a resource that is the same as an interlace and/or a guardband included in the initial transmission resource.

The sidelink transmission apparatus in this embodiment of this application may be an electronic device, for example, an electronic device with an operating system, or may be a component such as an integrated circuit or a chip in the electronic device. The electronic device may be a terminal device. For example, the terminal device may include but is not limited to the foregoing listed terminal device 11.

The sidelink transmission apparatus provided in this embodiment of this application can implement processes implemented in the method embodiment of FIG. 5, and achieve same technical effects. To avoid repetition, details are not described herein again.

Optionally, as shown in FIG. 11, an embodiment of this application further provides a communication device 900, including a processor 901 and a memory 902. The memory 902 stores a program or instructions that can be run on the processor 901. For example, when the communication device 900 is a network side device, the steps of the foregoing sidelink transmission method embodiment in the first aspect are implemented when the program or the instructions are executed by the processor 901, and the same technical effects can be achieved. When the communication device 900 is a terminal device, the steps of the foregoing sidelink transmission method embodiment in the second aspect are implemented when the program or the instructions are executed by the processor 901, and the same technical effects can be achieved. To avoid repetition, details are not described herein again.

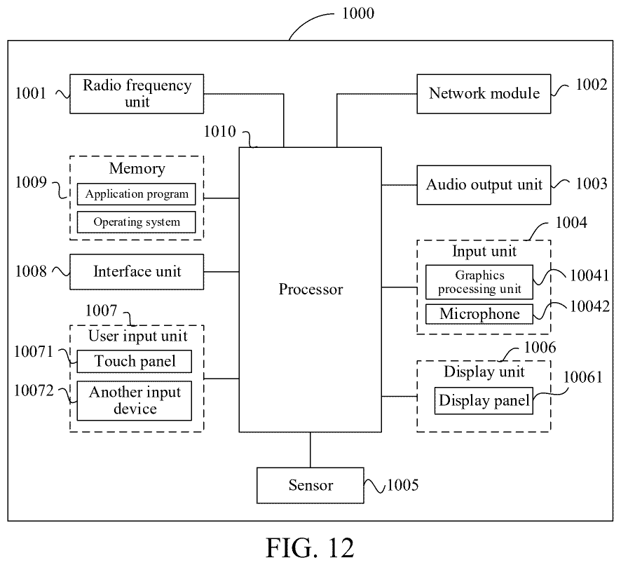

FIG. 12 is a schematic diagram of a hardware structure of a terminal device according to an embodiment of this application.

The terminal device 1000 includes but is not limited to at least a part of components of a radio frequency unit 1001, a network module 1002, an audio output unit 1003, an input unit 1004, a sensor 1005, a display unit 1006, a user input unit 1007, an interface unit 1008, a memory 1009, a processor 1010, and the like.

It can be understood by a person skilled in the art that the terminal device 1000 may further include a power supply (such as a battery) for supplying power to various components. The power supply may be logically connected to the processor 1010 by using a power management system, so as to achieve charging, discharging, power consumption management and other functions by using the power management system. The terminal device structure shown in FIG. 10 does not constitute a limitation on the terminal device. The terminal device may include more or fewer components than those shown, or combine some components, or have different component arrangements. Details are not described herein.

It should be understood that in this embodiment of this application, the input unit 1004 may include a graphics processing unit (GPU) 10041 and a microphone 10042. The graphics processing unit 10041 processes image data of a static picture or a video that is obtained by an image capture apparatus (such as a camera) in a video capture mode or an image capture mode. The display unit 1006 can include a display panel 10061, and the display panel 10061 can be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 can include but is not limited to a physical keyboard, a function key (such as a volume control key or an on/off key), a trackball, a mouse, and a joystick. Details are not described herein again.

In this embodiment of this application, after receiving downlink data from a network-side device, the radio frequency unit 1001 can transmit the downlink data to the processor 1010 for processing. In addition, the radio frequency unit 1001 can send uplink data to the network-side device. Generally, the radio frequency unit 1001 includes but is not limited to an antenna, an amplifier, a transceiver, a coupler, a low-noise amplifier, a duplexer, and the like.

The memory 1009 may be configured to store a software program or instructions and various types of data. The memory 1009 can mainly include a first storage area for storing a program or instructions and a second storage area for storing data. The first storage area can store an operating system, an application program or instructions required by at least one function (for example, a sound play function or an image play function), and the like. In addition, the memory 1009 can include a volatile memory or a nonvolatile memory, or the memory 1009 can include both a volatile memory and a nonvolatile memory. The nonvolatile memory can be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory can be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1009 in this embodiment of this application includes but is not limited to these memories and any other suitable type of memory.

The processor 1010 may include one or more processing units. Optionally, the processor 1010 integrates an application processor and a modem processor. The application processor mainly processes operations involving an operating system, a user interface, an application, and the like. The modem processor mainly processes a wireless communication signal, and is, for example, a baseband processor. It can be understood that, the foregoing modem processor may not be integrated into the processor 1010.

The processor 1010 is configured to determine a transport block size and/or second-stage sidelink control information according to first information.

The radio frequency unit 1001 is configured to perform sidelink transmission according to the transport block size and/or the second-stage sidelink control information.

The first information includes at least one of the following:
a first parameter, where the first parameter is used for indicating time domain resource information used for sidelink transmission in one slot;
a first coefficient, where the first coefficient is used for indicating a scaling ratio of a resource used for sidelink transmission in one slot; and
information about physical resource blocks scheduled by the terminal device.

Optionally, the first information includes the first parameter, and the processor 1010 is specifically configured to:
determine a scheduling symbol number according to second information; and
determine the transport block size and/or the second-stage sidelink control information according to the scheduling symbol number;
where the second information includes at least one of the following:
a first parameter, where the first parameter is used for indicating time domain resource information used for sidelink transmission in one slot;
an automatic gain control symbol number, where the automatic gain control symbol number is used for indicating a number of symbols occupied by automatic gain control in one slot; and
a guard symbol number, where the guard symbol number is used for indicating a number of symbols occupied by a guard period.

Optionally, the first coefficient is determined according to the first parameter.

Optionally, the first information includes the first parameter, and the processor 1010 is specifically configured to:
calculate a difference between a scheduling symbol number and a second parameter, where the scheduling symbol number is used for indicating a number of symbols used for sidelink transmission in one slot, and the second parameter is used for indicating a sidelink transmission overhead in one slot; and
determine the transport block size and/or the second-stage sidelink control information according to the difference between the scheduling symbol number and the second parameter.

The second parameter includes a third parameter and/or a physical sidelink feedback channel PSFCH overhead, the third parameter is determined according to the first parameter, and the PSFCH overhead is determined according to PSFCH configuration information and/or the first parameter.

Optionally, the information about the physical resource block scheduled by the terminal device includes at least one of the following:
a number of physical resource blocks scheduled by the terminal device;
a number of resource elements included in the physical resource block;
a number of resource elements occupied by first-stage sidelink control information; and
a number of resource elements occupied by the second-stage sidelink control information.

Optionally, the number of physical resource blocks scheduled by the terminal device is determined according to third information, and the third information includes at least one of the following:
a number of subchannels scheduled by the terminal device;
a number of interlaces occupied by the subchannel;
a number of reference physical resource blocks occupied by the interlace;
a number of physical resource blocks occupied by the interlace; and
a second coefficient, where the second coefficient is used for indicating a scaling ratio of a resource used for sidelink transmission in one slot.

Optionally, the number of reference physical resource blocks occupied by the interlace is determined according to fourth information, and the fourth information includes at least one of the following:
a subcarrier spacing;
a guardband configuration;
a resource block set;
a mapping manner of the second-stage sidelink control information;
a first indication, where the first indication is used for indicating the number of reference physical resource blocks occupied by the interlace;
a number of reference physical resource blocks occupied by an interlace configured by at least one of a protocol, a network side device, and the terminal device; and
in interlaces occupied by each subchannel scheduled by the terminal device, a minimum value, a maximum value, or an average value in numbers of reference physical resource blocks occupied by the interlaces.

Optionally, the second coefficient is determined according to the number of reference physical resource blocks occupied by the interlace.

Optionally, the physical resource block scheduled by the terminal device is determined according to fifth information, and the fifth information includes at least one of the following:
a reference resource scheduled by the terminal device;
a number of reference physical resource blocks occupied by the subchannel; and
a third coefficient, where the third coefficient is used for indicating a scaling ratio of a resource used for sidelink transmission in one slot.

Optionally, the reference resource scheduled by the terminal device meets a first condition, and the first condition includes at least one of the following:
a start resource and/or an end resource of the reference resource scheduled by the terminal device includes or does not include a subchannel overlapping a guardband; and
the reference resource scheduled by the terminal device includes or does not include a resource in a guardband and/or a rest resource in a resource set, where the rest resource in the resource set is a resource that is in the resource set and that is insufficient to form one subchannel.

Optionally, the number of physical resource blocks scheduled by the terminal device includes at least one of the following:
if the start resource and/or the end resource of the reference resource scheduled by the terminal device does not include a subchannel overlapping a guardband, the number of physical resource blocks scheduled by the terminal device is equal to a first value, where the first value is a product of the number of subchannels scheduled by the terminal device and the number of reference physical resource blocks occupied by the subchannel;
if the reference resource scheduled by the terminal device includes a resource of a guardband, the number of physical resource blocks scheduled by the terminal device is a difference between the first value and a second value, where the second value is a number of physical resource blocks that include a guardband and that are in the reference resource scheduled by the terminal device;
if the reference resource scheduled by the terminal device does not include a resource of a guardband, the number of physical resource blocks scheduled by the terminal device is the first value;
if the start resource and/or the end resource of the reference resource scheduled by the terminal device includes a subchannel overlapping a guardband, the number of physical resource blocks scheduled by the terminal device includes at least one of the following:
a difference between the first value and a third value, where the third value is a number of physical resource blocks occupied by a part that overlaps the guardband and that is of the subchannel that is in the reference resource scheduled by the terminal device and that overlaps the guardband;
a product of a fourth value and the number of reference physical resource blocks occupied by the subchannel, where the fourth value is a difference between the number of subchannels scheduled by the terminal device and a number of subchannels that are in the reference resource scheduled by the terminal device and that overlap the guardband; and
the first value.

Optionally, the number of physical resource blocks scheduled by the terminal device includes at least one of the following:
if the reference resource scheduled by the terminal device does not include a resource of a guardband and/or a rest resource in a resource set, the number of physical resource blocks scheduled by the terminal device is equal to a first value, where the first value is a product of the number of subchannels scheduled by the terminal device and the number of reference physical resource blocks occupied by the subchannel;
if the reference resource scheduled by the terminal device includes the resource of the guardband and/or the rest resource in the resource set, the number of physical resource blocks scheduled by the terminal device is equal to a sum of the first value and a fifth value, where the fifth value is a number of physical resource blocks that include the resource of the guardband and/or the rest resource in the resource set and that are in the reference resource scheduled by the terminal device;
if the second-stage sidelink control information is not mapped on the resource of the guardband and/or the rest resource in the resource set, the number of physical resource blocks scheduled by the terminal device is equal to the first value; and
if the reference resource scheduled by the terminal device includes the resource of the guardband, the number of physical resource blocks scheduled by the terminal device is equal to a sum of the first value and a sixth value, where the sixth value is a number of physical resource blocks that are in the resource of the guardband included in the reference resource scheduled by the terminal device and that do not overlap the subchannel scheduled by the terminal device.

Optionally, the resource of the guardband and/or the rest resource in the resource set includes at least one subchannel.

Optionally, the number of subchannels scheduled by the terminal device further includes a number of subchannels determined based on at least one guardband and/or at least one rest physical resource block.

Optionally, the number of reference physical resource blocks occupied by the subchannel includes at least one of the following:
a number of physical resource blocks occupied by a subchannel that divides a resource block set;
a number of physical resource blocks obtained after physical resource blocks in the resource block set are evenly divided into subchannels scheduled by the terminal device; and
a number of physical resource blocks obtained after physical resource blocks in a first set are evenly divided into the subchannels scheduled by the terminal device, where the first set includes each physical resource block in the resource block set and a physical resource block occupied by a guardband.

Optionally, the third coefficient includes at least one of the following:
if a start resource and/or an end resource of the reference resource scheduled by the terminal device do not include a subchannel overlapping a guardband, the third coefficient is a first preset value;
if the start resource and/or the end resource of the reference resource scheduled by the terminal device include a subchannel overlapping the guardband, the third coefficient is a second preset value;
if the reference resource scheduled by the terminal device does not include a resource of the guardband and/or a rest resource in a resource set, the third coefficient is a third preset value; and
if the reference resource scheduled by the terminal device includes the resource of the guardband and/or the rest resource in the resource set, the third coefficient is a fourth preset value.

Optionally, the number of physical resource blocks scheduled by the terminal device is a product of the number of subchannels scheduled by the terminal device, the number of reference physical resource blocks occupied by the subchannel, and the third coefficient.

Optionally, the number of physical resource blocks scheduled by the terminal device is equal to a product of the number of subchannels scheduled by the terminal device and the number of reference physical resource blocks occupied by the subchannel.

Optionally, the second-stage sidelink control information is not mapped on the resource of the guardband and/or the rest resource in the resource set.

Optionally, the first parameter is determined according to sixth information, and the sixth information includes at least one of the following:
a reference symbol number;
a start symbol position;
a second indication, where the second indication is used for indicating a determining manner of the first parameter; and
the first parameter configured by at least one of a protocol, a network side device, and the terminal device.

Optionally, the processor 1010 is specifically configured to: determine a transport block according to the first parameter and monitor a channel corresponding to the transport block, to obtain a monitoring result; and
the radio frequency unit 1001 is specifically configured to perform sidelink transmission according to the monitoring result.

Optionally, the first parameter includes a first reference symbol length determined based on a first start symbol, and the radio frequency unit 1001 is specifically configured to:
perform, by the terminal device, sidelink transmission based on a transport block corresponding to the first reference symbol length if the terminal device successfully monitors before a moment corresponding to the first start symbol; or
perform, by the terminal device, sidelink transmission based on a transport block in a next slot or a transport block determined according to a next first start symbol if the terminal device fails to monitor before a moment corresponding to the first start symbol and successfully monitors before a moment corresponding to the second start symbol.

Optionally, a reference symbol length of the transport block is determined according to seventh information, and the seventh information includes at least one of the following:
a traffic type;
a channel busy ratio;
a channel occupancy ratio;
a channel monitoring result;
a modulation coding scheme;
a target code rate;
a priority of the transport block; and
a rest packet delay budget.

Optionally, the processor 1010 is specifically configured to:
perform, by the terminal device, rate matching on the transport block according to the first reference symbol length; and/or
perform, by the terminal device, rate matching on the transport block according to the second reference symbol length if channel access of the terminal device fails before a moment corresponding to the first start symbol; and
the radio frequency unit 1001 is specifically configured to perform sidelink transmission according to the monitoring result and a transport block after the rate matching.

Optionally, the radio frequency unit 1001 is further configured to:
perform retransmission based on the monitoring result if an initial transmission resource of the terminal device is a resource determined based on a first start symbol.

Optionally, the radio frequency unit 1001 is specifically configured to:
perform retransmission based on a first resource if channel access of the terminal device succeeds before a moment corresponding to a first start symbol of the first resource in a case that the initial transmission resource of the terminal device is the resource determined based on the first start symbol; or
perform retransmission based on a second resource if channel access of the terminal device succeeds before a moment corresponding to a second start symbol of the first resource.

The first resource and the initial transmission resource include a same transport block, the second resource includes a transport block that belongs to a different hybrid automatic repeat request procedure from the initial transmission resource, and/or a transport block that belongs to a different redundancy version from the initial transmission resource.

Optionally, the first resource includes at least one of the following:
if the initial transmission resource of the terminal device is the resource determined based on the first start symbol, the terminal device determines that the first resource is the resource determined based on the first start symbol; or
if the initial transmission resource of the terminal device is a resource determined based on the second start symbol, the terminal device determines that the first resource is the resource determined based on the second start symbol.

Optionally, the first resource includes a resource that is the same as an interlace and/or a guardband included in the initial transmission resource.

An embodiment of this application further provides a readable storage medium. The readable storage medium stores a program or instructions. When the program or instructions are executed by a processor, each process of the foregoing sidelink transmission method embodiment is implemented, with the same technical effect achieved. To avoid repetition, details are not described herein again.

The processor is a processor in the terminal device in the foregoing embodiment. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing sidelink transmission method embodiment, and the same technical effects can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium. The computer program/program product is executed by at least one processor to implement the processes in the foregoing sidelink transmission method embodiment, and the same technical effects can be achieved. To avoid repetition, details are not described herein again.

An embodiment of this application further provides a sidelink transmission system, including a terminal device and a network side device, where the terminal may be configured to perform the step of the sidelink transmission method according to the second aspect, and the network side device may be configured to perform the step of the sidelink transmission method according to the first aspect.

It should be noted that, the terms “include”, “comprise”, or any other variation thereof in this specification are intended to cover a non-exclusive inclusion, so that a process, method, article, or apparatus that includes a list of elements includes the elements, and also includes other elements that are not expressly listed, or further includes elements inherent to such a process, method, article, or apparatus. Without more limitations, elements defined by the sentence “including one” does not exclude that there are still other same elements in the processes, methods, objects, or apparatuses that include the elements. In addition, it should be noted that the scope of the method and apparatus in the embodiments of this application is not limited to performing a function in a sequence shown or discussed, and may further include performing a function in a basically simultaneous manner or in a reverse sequence based on a related function. For example, the described method may be performed in an order different from the described order, and various steps may be added, omitted, or combined. In addition, features described with reference to some examples may be combined in other examples.

Based on the descriptions in the foregoing implementations, a person skilled in the art may clearly learn that the method in the foregoing embodiment may be implemented by software in addition to a necessary universal hardware platform or by hardware. In most circumstances, the former is a better implementation. Based on such an understanding, the technical solutions of this application essentially, or the part contributing to the prior art, may be presented in the form of a computer software product. The computer software product is stored in a storage medium (for example, a ROM/RAM, a magnetic disk, or an optical disc) including several instructions to enable a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. The foregoing specific implementations are merely examples, and are not restrictive. Under the enlightenment of this application, many forms may be further made by a person of ordinary skill in the art without departing from the objective of this application and the protection scope of the claims and shall fall within the protection scope of this application.

What is claimed is:

1. A sidelink transmission method, wherein the method comprises:
determining, by a terminal device, at least one of a transport block size or second-stage sidelink control information according to first information; and
performing, by the terminal device, sidelink transmission according to at least one of the transport block size or the second-stage sidelink control information;
wherein the first information comprises at least one of the following:
a first parameter, wherein the first parameter is used for indicating time domain resource information used for sidelink transmission in one slot;
a first coefficient, wherein the first coefficient is used for indicating a scaling ratio of a resource used for sidelink transmission in one slot; and
information about physical resource blocks scheduled by the terminal device.

2. The method according to claim 1, wherein the first information comprises the first parameter, and the determining, by a terminal device, at least one of a transport block size or second-stage sidelink control information according to first information comprises:
determining, by the terminal device, a scheduling symbol number according to second information; and
determining, by the terminal device, at least one of the transport block size or the second-stage sidelink control information according to the scheduling symbol number;
wherein the second information comprises at least one of the following:
the first parameter;
an automatic gain control symbol number, wherein the automatic gain control symbol number is used for indicating a number of symbols occupied by automatic gain control in one slot; and
a guard symbol number, wherein the guard symbol number is used for indicating a number of symbols occupied by a guard period.

3. The method according to claim 1, wherein the first information comprises the first parameter, and the determining, by a terminal device, at least one of a transport block size or second-stage sidelink control information according to first information comprises:
calculating, by the terminal device, a difference between a scheduling symbol number and a second parameter, wherein the scheduling symbol number is used for indicating a number of symbols used for sidelink transmission in one slot, and the second parameter is used for indicating a sidelink transmission overhead in one slot; and
determining, by the terminal device, at least one of the transport block size or the second-stage sidelink control information according to the difference between the scheduling symbol number and the second parameter;
wherein the second parameter comprises at least one of a third parameter or a physical sidelink feedback channel PSFCH overhead, the third parameter is determined according to the first parameter, and the PSFCH overhead is determined according to at least one of PSFCH configuration information or the first parameter.

4. The method according to claim 1, wherein the information about the physical resource block scheduled by the terminal device comprises at least one of the following:
a number of physical resource blocks scheduled by the terminal device;
a number of resource elements comprised in the physical resource block;
a number of resource elements occupied by first-stage sidelink control information; and
a number of resource elements occupied by the second-stage sidelink control information.

5. The method according to claim 4, wherein the number of physical resource blocks scheduled by the terminal device is determined according to third information, and the third information comprises at least one of the following:
a number of subchannels scheduled by the terminal device;
a number of interlaces occupied by the subchannel;
a number of reference physical resource blocks occupied by the interlace;
a number of physical resource blocks occupied by the interlace; and
a second coefficient, wherein the second coefficient is used for indicating a scaling ratio of a resource used for sidelink transmission in one slot.

6. The method according to claim 5, wherein the number of reference physical resource blocks occupied by the interlace is determined according to fourth information, and the fourth information comprises at least one of the following:
a subcarrier spacing;
a guardband configuration;
a resource block set;
a mapping manner of the second-stage sidelink control information;
a first indication, wherein the first indication is used for indicating the number of reference physical resource blocks occupied by the interlace;
a number of reference physical resource blocks occupied by an interlace configured by at least one of a protocol, a network side device, and the terminal device; and
in interlaces occupied by each subchannel scheduled by the terminal device, a minimum value, a maximum value, or an average value in numbers of reference physical resource blocks occupied by the interlaces.

7. The method according to claim 5, wherein the physical resource block scheduled by the terminal device is determined according to fifth information, and the fifth information comprises at least one of the following:
a reference resource scheduled by the terminal device;
a number of reference physical resource blocks occupied by the subchannel; and
a third coefficient, wherein the third coefficient is used for indicating a scaling ratio of a resource used for sidelink transmission in one slot.

8. The method according to claim 7, wherein the number of reference physical resource blocks occupied by the subchannel comprises at least one of the following:
a number of physical resource blocks occupied by a subchannel that divides a resource block set;
a number of physical resource blocks obtained after physical resource blocks in the resource block set are evenly divided into subchannels scheduled by the terminal device; and
a number of physical resource blocks obtained after physical resource blocks in a first set are evenly divided into the subchannels scheduled by the terminal device, wherein the first set comprises each physical resource block in the resource block set and a physical resource block occupied by a guardband.

9. The method according to claim 7, wherein the number of physical resource blocks scheduled by the terminal device is equal to a product of the number of subchannels scheduled by the terminal device and the number of reference physical resource blocks occupied by the subchannel.

10. The method according to claim 1, wherein the first parameter is determined according to sixth information, and the sixth information comprises at least one of the following:
a reference symbol number;
a start symbol position;
a second indication, wherein the second indication is used for indicating a determining manner of the first parameter; and
the first parameter configured by at least one of a protocol, a network side device, and the terminal device.

11. A terminal device, comprising at least one hardware processor and a memory, wherein the memory stores a program or instructions executable by the at least one hardware processor that, when executed, direct the at least one hardware processor to implement:
determining at least one of a transport block size or second-stage sidelink control information according to first information; and
performing sidelink transmission according to at least one of the transport block size or the second-stage sidelink control information;
wherein the first information comprises at least one of the following:
a first parameter, wherein the first parameter is used for indicating time domain resource information used for sidelink transmission in one slot;
a first coefficient, wherein the first coefficient is used for indicating a scaling ratio of a resource used for sidelink transmission in one slot; and
information about physical resource blocks scheduled by the terminal device.

12. The terminal device according to claim 11, wherein the first information comprises the first parameter, and the at least one hardware processor is further directed to:
determine a scheduling symbol number according to second information; and
determine at least one of the transport block size or the second-stage sidelink control information according to the scheduling symbol number;
wherein the second information comprises at least one of the following:
the first parameter;
an automatic gain control symbol number, wherein the automatic gain control symbol number is used for indicating a number of symbols occupied by automatic gain control in one slot; and
a guard symbol number, wherein the guard symbol number is used for indicating a number of symbols occupied by a guard period.

13. The terminal device according to claim 11, wherein the first information comprises the first parameter, and the at least one hardware processor is further directed to:
calculate a difference between a scheduling symbol number and a second parameter, wherein the scheduling symbol number is used for indicating a number of symbols used for sidelink transmission in one slot, and the second parameter is used for indicating a sidelink transmission overhead in one slot; and
determine at least one of the transport block size or the second-stage sidelink control information according to the difference between the scheduling symbol number and the second parameter;
wherein the second parameter comprises at least one of a third parameter or a physical sidelink feedback channel PSFCH overhead, the third parameter is determined according to the first parameter, and the PSFCH overhead is determined according to at least one of PSFCH configuration information or the first parameter.

14. The terminal device according to claim 11, wherein the information about the physical resource block scheduled by the terminal device comprises at least one of the following:
a number of physical resource blocks scheduled by the terminal device;
a number of resource elements comprised in the physical resource block;
a number of resource elements occupied by first-stage sidelink control information; and
a number of resource elements occupied by the second-stage sidelink control information.

15. The terminal device according to claim 14, wherein the number of physical resource blocks scheduled by the terminal device is determined according to third information, and the third information comprises at least one of the following:
a number of subchannels scheduled by the terminal device;
a number of interlaces occupied by the subchannel;
a number of reference physical resource blocks occupied by the interlace;
a number of physical resource blocks occupied by the interlace; and
a second coefficient, wherein the second coefficient is used for indicating a scaling ratio of a resource used for sidelink transmission in one slot.

16. The terminal device according to claim 15, wherein the number of reference physical resource blocks occupied by the interlace is determined according to fourth information, and the fourth information comprises at least one of the following:
a subcarrier spacing;
a guardband configuration;
a resource block set;
a mapping manner of the second-stage sidelink control information;
a first indication, wherein the first indication is used for indicating the number of reference physical resource blocks occupied by the interlace;
a number of reference physical resource blocks occupied by an interlace configured by at least one of a protocol, a network side device, and the terminal device; and
in interlaces occupied by each subchannel scheduled by the terminal device, a minimum value, a maximum value, or an average value in numbers of reference physical resource blocks occupied by the interlaces.

17. The terminal device according to claim 15, wherein the physical resource block scheduled by the terminal device is determined according to fifth information, and the fifth information comprises at least one of the following:
a reference resource scheduled by the terminal device;
a number of reference physical resource blocks occupied by the subchannel; and
a third coefficient, wherein the third coefficient is used for indicating a scaling ratio of a resource used for sidelink transmission in one slot.

18. The terminal device according to claim 17, wherein the number of reference physical resource blocks occupied by the subchannel comprises at least one of the following:
a number of physical resource blocks occupied by a subchannel that divides a resource block set;
a number of physical resource blocks obtained after physical resource blocks in the resource block set are evenly divided into subchannels scheduled by the terminal device; and
a number of physical resource blocks obtained after physical resource blocks in a first set are evenly divided into the subchannels scheduled by the terminal device, wherein the first set comprises each physical resource block in the resource block set and a physical resource block occupied by a guardband,
or
wherein the number of physical resource blocks scheduled by the terminal device is equal to a product of the number of subchannels scheduled by the terminal device and the number of reference physical resource blocks occupied by the subchannel.

19. The terminal device according to claim 11, wherein the first parameter is determined according to sixth information, and the sixth information comprises at least one of the following:
a reference symbol number;
a start symbol position;
a second indication, wherein the second indication is used for indicating a determining manner of the first parameter; and
the first parameter configured by at least one of a protocol, a network side device, and the terminal device.

20. A non-transitory computer-readable storage medium, storing a program or instructions, wherein the program or the instructions, when executed by at least one hardware processor, direct the at least one hardware processor to implement:
determining at least one of a transport block size or second-stage sidelink control information according to first information; and
performing sidelink transmission according to at least one of the transport block size or the second-stage sidelink control information;
wherein the first information comprises at least one of the following:
a first parameter, wherein the first parameter is used for indicating time domain resource information used for sidelink transmission in one slot;
a first coefficient, wherein the first coefficient is used for indicating a scaling ratio of a resource used for sidelink transmission in one slot; and
information about physical resource blocks scheduled by the terminal device.
